(19) United States
(12) Patent Application Publication
(10) Pub. No.: US 2014/0244794 A1
(43) Pub. Date: Aug. 28, 2014

(54) Information System, Method and Program for Managing the Same, Method and Program for Processing Data, and Data Structure

(71) Applicant: NEC CORPORATION, Minato-ku, Tokyo (JP)

(72) Inventor: Shinji Nakadai, Tokyo (JP)

(73) Assignee: NEC CORPORATION, Tokyo (JP)

(21) Appl. No.: 14/348,041

(22) PCT Filed: Sep. 26, 2012
(86) PCT No.: PCT/JP2012/006152

§ 371 Date: Mar. 27, 2014

(30) Foreign Application Priority Data
Sep. 27, 2011 (JP) 2011-211157

(51) Int. Cl. H04L 29/08

(52) U.S. Cl. CPC H04L 67/104
USPC 709/217

(57) ABSTRACT

An information system includes a plurality of data storage servers that manage a data constellation in a distributed manner, an ID assigning unit (112) that assigns logical identifiers to the plurality of data storage servers on a logical identifier space, a range determination unit (114) that correlates a distribution of data in the data constellation with the logical identifier space so as to determine a range of values of the data corresponding to the logical identifier, and a destination resolving unit (340) that obtains, when searching for the destination of a node which stores any data having any attribute value or any attribute range, a logical identifier corresponding to a range of an attribute value space of the data which matches at least a part of the attribute value or the attribute range, on the basis of a correspondence relation among the range of values of the data, the logical identifier, and the destination address, with respect to each of the data storage servers, and determines the destination address of the data storage server corresponding to the logical identifier as a destination.

### TECHNICAL FIELD

The present invention relates to an information system, method and program for managing the same, method and program for processing data, and a data structure, and, particularly to an information system which manages distributed data, method and program for managing the same, method and program for processing data, and a data structure.

### BACKGROUND ART

Patent Document 1 discloses a distributed database system in which each record of data is divided into a plurality of records which are stored in a plurality of storage devices (first processors). In this system, a range, in which key values of all the records of table data which forms the data are distributed, is divided into a plurality of sections. In this case, the number of records in each section is made the same, and a plurality of first processors are respectively assigned to a plurality of sections. A central processor accesses the first processor. The key values of the plurality of records of each part of a database held by the first processor and information indicating a storage location of the records are transferred to a second processor assigned with the section of the key value to which each record belongs.

In addition, the key value of the records held thereby and information indicating a storage location of the records are transferred to the first processor assigned with the section to which the key value belongs. The second processor sorts the plurality of transferred key values, and generates a key value table in which the information indicating the storage location of the record which is received together with the key value is registered, as a sorting result. With the configuration, in the system disclosed in Patent Document 1, efficiency of a sorting process in the distributed database system is improved by reducing a load on the central processor which accesses the first processor.

In addition, an overlay management system disclosed in Patent Document 2 includes a space-filling curve conversion processing unit, a distribution function processing unit, and a message transfer processing unit.

The overlay management system having the configuration operates as follows. The system selects a plurality of attributes (attributes attached with composite indexes) which are designated in advance for retrieval efficiency, from data, when an operation of registration or deletion of the data is performed. In addition, a multi-dimensional value is acquired, and is converted to derive a one-dimensional value by the space-filling curve processing unit. The value is input to the distribution function processing unit, and a logical identifier is obtained as a uniformized one-dimensional value.

This logical identifier is used to determine a storage destination of data or a transfer destination of requested information. Here, the message transfer process unit transmits the requested information by using the obtained logical identifier as a destination. The message transfer processing unit transmits the message to a peer which manages the corresponding logical identifier, so that the data is registered in or is deleted in the peer.

As above, the distribution function is applied to an attribute value, and data of the attribute value is stored using the logical identifier which is stochastically uniformly distributed in the same manner as a logical identifier assigned to a node which is a data storage destination. Therefore, it is possible to realize stochastic uniformization of a load.

In addition, when an operation for data range retrieval is performed, a conditional expression regarding a range of a plurality of attributes attached with composite indexes is acquired from a retrieval expression, and a plurality of ranges of one-dimensional values are obtained from the multi-dimensional range by using the space-filling curve processing unit. The distribution function processing unit applies a distribution function to each of the ranges of one-dimensional values so as to acquire a logical identifier, and performs this process on all the plurality of one-dimensional values so as to obtain a plurality of logical identifier ranges.

The message transfer processing unit transmits a retrieval request by using the plurality of logical identifier ranges obtained in this way as destinations, and acquires data stored in a plurality of peers corresponding to the destinations.

In addition, Patent Document 3 and Non-Patent Document 1 disclose a space-filling curve process. Further, Non-Patent Document 2 discloses a Multi-Attribute Addressable Network for Grid Information Services (MAAN) which extends to Chord to support queries of multi-attribute and range using a multi-dimensional attribute in a Peer-to-Peer (P2P) system such as a Distributed Hash Table (DHT). Here, Chord is one of algorithms for realizing a distributed hash table. A P2P network is a technique of retrieving content and of routing a message from a certain node to another node at a high speed without using a server. The distributed hash table is a technique of routing an access request to a hash table, particularly, as a P2P network, among techniques in which a hash table is managed by a plurality of peers.

### RELATED DOCUMENT

### Patent Document

[Patent Document 1] Japanese Unexamined Patent Publication No. H5-242049
[Patent Document 2] Japanese Unexamined Patent Publication No. 2008-234563
[Patent Document 3] Specification of U.S. Pat. No. 7,167,856

### Non-Patent Document

[Non-Patent Document 1] J. K. Lawder, and one other, “Querying Multi-dimensional Data Indexed Using the Hilbert Space-filling Curve”, ACM SIGMOD (Special Interest Group on Data Communication) Record, March, 2001, vol. 30, No. 1, pp. 19 to 24
[Non-Patent Document 2] Min Cai, and three others, “MAAN: A Multi-Attribute Addressable Network for Grid Information Services”, Journal of Grid Computing, March, 2004, vol. 2, No. 1, pp. 3 to 14

### DISCLOSURE OF THE INVENTION

In the above-described system disclosed in Patent Document 1, in a case where a distribution of records stored in the first processors changes over time, and thus a load on each processor changes, it is considered that the first processor is installed more or stops being used. In this case, there is a problem in that the records are required to be moved among all the first processors in the entire database in order to strictly uniformize the number of records in the plurality of processors, and thus the records are frequently moved.

The reason is as follows. For example, it is assumed that a data amount of 1/N is assigned to each of N nodes in order to strictly uniformize the data amount, then one more node is installed, and a data amount of 1/(N+1) is assigned to each of the nodes. In this case, data is moved in almost all of the nodes, and a node which moves almost all data occurs. Conversely, if data is moved in only one node selected from the N nodes, the data is ununiformly stored, and a data amount stored in a certain node is only a half of a data amount stored in other nodes.

An object of the present invention is to solve the above-described problems and to thus provide an information system in which an amount of moved data is small when a data storing computer is changed while maintaining a load between nodes to be appropriately uniform, method and program for managing the same, method and program for processing data, and a data structure.

According to the present invention, there is provided an information system which includes a plurality of nodes that manage a data constellation in a distributed manner, the plurality of nodes respectively having destination addresses being identifiable on a network; an identifier assigning unit that assigns logical identifiers to the plurality of nodes on a logical identifier space; a range determination unit that correlates a distribution of data in the data constellation with the logical identifier space so as to determine a range of values of the data corresponding to the logical identifier of each of the nodes; and a destination determination unit that obtains, when searching for a destination of a node which stores any data having any attribute value or any attribute range, a logical identifier corresponding to a range of the data which matches at least a part of the attribute value or the attribute range, on the basis of a correspondence relation among the range of values of the data, the logical identifier, and the destination address, with respect to each of the nodes, and determines the destination address of the node corresponding to the logical identifier as a destination.

According to the present invention, there is provided a method for managing an information system which manages a plurality of nodes that manage a data constellation in a distributed manner, the plurality of nodes respectively having destination addresses being identifiable in a network, and the information system including a management apparatus and a storage device, in which the method for managing includes: assigning, by the management apparatus, logical identifiers to the plurality of nodes on a logical identifier space; correlating, by the management apparatus, a distribution of data in the data constellation with the logical identifier space so as to determine a range of values of the data corresponding to the logical identifier of each of the nodes; and obtaining, when searching for the destination of a node which stores any data having any attribute value or any attribute range, by the management apparatus, a logical identifier corresponding to a range of the data which matches at least apart of the attribute value or the attribute range, on the basis of a correspondence relation among the range of values of the data, the logical identifier, and the destination address, with respect to each of the nodes so as to determine the destination address of the node corresponding to the logical identifier as a destination.

According to the present invention, there is provided a program for a computer realizing a management apparatus which manages a plurality of nodes that manage a data constellation in a distributed manner, the plurality of nodes respectively having destination addresses being identifiable on a network, and the management apparatus including a storage device, in which the program causes the computer realizing the management apparatus to execute: a procedure for assigning logical identifiers to the plurality of nodes on a logical identifier space; a procedure for correlating a distribution of data in the data constellation with the logical identifier space so as to determine a range of values of the data corresponding to the logical identifier of each of the nodes; and a procedure for obtaining, when searching for the destination of a node which stores any data having any attribute value or any attribute range, a logical identifier corresponding to a range of the data which matches at least a part of the attribute value or the attribute range, on the basis of a correspondence relation among the range of values of the data, the logical identifier, and the destination address of each of the nodes, and determining the destination address of the node corresponding to the logical identifier as a destination.

According to the present invention, there is provided a method for processing data of a terminal apparatus which is connected to the management apparatus employing the method for managing an information system and accesses the data through the management apparatus, in which the method for processing data includes notifying, by the terminal apparatus, the management apparatus of an access request for data having an attribute value or an attribute range; and accessing, by the terminal apparatus, a destination of the node managing the data in a range which matches at least a part of the access-requested attribute value or attribute range, through the management apparatus, on the basis of correspondence relations among destination addresses of the plurality of nodes, logical identifiers assigned to the respective nodes, and ranges of values of the data managed by the respective nodes, so as to operate the data.

According to the present invention, there is provided a program for a computer realizing a client terminal connected to a server which manages a plurality of nodes that manage a data constellation in a distributed manner, the plurality of nodes respectively having destination addresses being identifiable on a network, in which the program causes the computer realizing the client terminal to execute: a procedure for receiving an access request for data having an attribute value or an attribute range; a procedure for notifying the server of the received access request; a procedure for obtaining the logical identifier corresponding to a range of the data which matches at least a part of the access-requested attribute value or attribute range on the basis of correspondence relations among destination addresses of the plurality of nodes, logical identifiers assigned to the respective nodes, and ranges of values of the data managed by the respective nodes so as to receive a destination address of the node corresponding to the logical identifier determined as the destination from the server; and a procedure for accessing the node having the destination address received from the server so as to operate the data having the attribute value or the attribute range.

According to the present invention, there is provided a data structure of a destination table which is referred to when determining destinations of a plurality of nodes which manage a data constellation in a distributed manner, in which the plurality of nodes respectively have destination addresses being identifiable on a network, in which the destination table includes correspondence relations among destination addresses of the plurality of nodes which manage the data constellation in a distributed manner, logical identifiers assigned to the respective nodes on a logical identifier space, and ranges of values of data managed by the respective nodes, and, in which, in relation to the range of values of the data of each of the nodes, a distribution of the data in the data constellation is correlated with the logical identifier space, and the range of values of the data corresponding to the logical identifier of each node is assigned to each node.

In addition, any combination of the above constituent elements is effective as an aspect of the present invention, and conversion results of expression of the present invention between a method, a device, a system, a recording medium, a computer program, and the like are also effective as an aspect of the present invention.

Further, various constituent elements of the present invention are not necessarily required to be present separately and independently, and may be one in which a single member is formed by a plurality of constituent elements, one in which a plurality of members form a single constituent element, one in which a certain constituent element is a part of another constituent element, one in which a part of a certain constituent element overlaps a part of another constituent element, and the like.

Furthermore, a plurality of procedures are sequentially described in the method and the computer program of the present invention, but the order of the description does not limit an order of a plurality of procedures to be executed. For this reason, in a case of performing the method and the computer program of the present invention, the order of the plurality of procedures may be changed within the scope without departing from the content thereof.

Moreover, a plurality of procedures of the method and the computer program of the present invention are not limited to being executed at different respective timings. For this reason, another procedure may occur during execution of a certain procedure, and an execution timing of a certain procedure may overlap a part of or the overall execution timing of another procedure.

According to the present invention, there are provided an information system which manages a storage destination of scalable data while maintaining a load between nodes to be uniform on the basis of a distribution of data of a data constellation, method and program for managing the same, method and program for processing data, and a data structure.

### BRIEF DESCRIPTION OF THE DRAWINGS

The above-described object, and other objects, features and advantages will become apparent from preferred exemplary embodiments described below and the following accompanying drawings.

FIG. 1 is a functional block diagram illustrating a configuration of an information system according to an exemplary embodiment of the present invention.

FIG. 2 is a block diagram illustrating a configuration example of computers of the information system according to the exemplary embodiment of the present invention.

FIG. 3 is a block diagram illustrating a configuration example of computers of the information system according to the exemplary embodiment of the present invention.

FIG. 4 is a functional block diagram illustrating a configuration of the information system according to the exemplary embodiment of the present invention.

FIG. 5 is a functional block diagram illustrating a main part configuration of the information system according to the exemplary embodiment of the present invention.

FIG. 6 is a diagram illustrating an example of a structure of a destination server information table of the information system according to the present exemplary embodiment.

FIG. 7 is a diagram illustrating a correspondence relation of the information system according to the exemplary embodiment of the present invention.

FIG. 8 is a flowchart illustrating an example of an operation of the information system according to the exemplary embodiment of the present invention.

FIG. 9 is a flowchart illustrating an example of an operation of the information system according to the exemplary embodiment of the present invention.

FIG. 10 is a functional block diagram illustrating a configuration of a schema management server of an information system according to the present exemplary embodiment.

FIG. 11 is a diagram illustrating a space-filling curve conversion rule in the information system according to the present exemplary embodiment.

FIG. 12 is a functional block diagram illustrating a configuration of a preprocessing unit of the information system according to the present exemplary embodiment.

FIG. 13 is a diagram illustrating an example of a structure of a space-filling curve server information table of the information system according to the present exemplary embodiment.

FIG. 14 is a functional block diagram illustrating a main part configuration of the information system according to the present exemplary embodiment.

FIG. 15 is a flowchart illustrating an example of an operation of a schema management server of the information system according to the present exemplary embodiment.

FIG. 16 is a flowchart illustrating an example of an operation of a preprocessing unit of the information system according to the present exemplary embodiment.

FIG. 17 is a flowchart illustrating an example of an operation of a process of determining a destination in a destination resolving unit of the information system according to the present exemplary embodiment.

FIG. 18 is a flowchart illustrating an example of an operation of a process of determining a plurality of destinations in the destination resolving unit of the information system according to the present exemplary embodiment.

FIG. 19 is a diagram illustrating an example of data distribution in the information system according to the present exemplary embodiment.

FIG. 20 is a diagram illustrating an example of a distribution width and a distribution amount corresponding to density distribution information in the information system according to the present exemplary embodiment.

FIG. 21 is a diagram illustrating an example of a cumulative distribution ratio and a one-dimensional value corresponding to cumulative distribution information in the information system according to the present exemplary embodiment.

FIG. 22 is a diagram illustrating an example of cumulative distribution information which is obtained by applying an inverse function in the information system according to the present exemplary embodiment.

FIG. 23 is a diagram illustrating an example of a logical identifier space in the information system according to the present exemplary embodiment.

FIG. 24 is a diagram illustrating a multi-dimensional attribute range included in a space-filling curve server information table in the information system according to the present exemplary embodiment.

FIG. 25 is a diagram illustrating an example of a structure of the space-filling curve server information table of the information system according to the present exemplary embodiment.

### DESCRIPTION OF EXEMPLARY EMBODIMENTS

Hereinafter, exemplary embodiments of the present invention will be described with reference to the drawings. In addition, throughout all the drawings, the same constituent elements are given the same reference numerals, and description thereof will not be repeated.

### First Exemplary Embodiment

Hereinafter, a best mode for carrying out the invention will be described in detail with reference to the drawings.

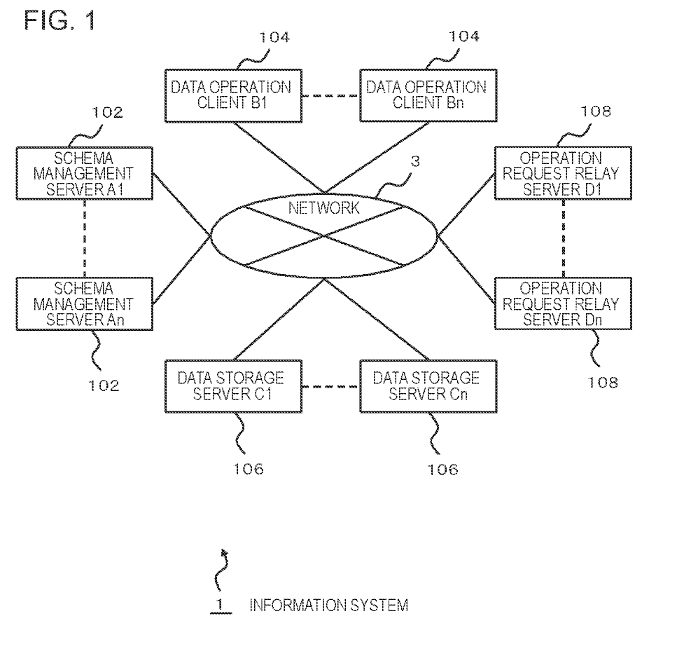

FIG. 1 is a functional block diagram illustrating a configuration of an information system 1 according to an exemplary embodiment of the present invention.

The information system 1 according to the exemplary embodiment of the present invention includes a plurality of computers which are connected to each other through a network 3, for example, a plurality of schema management servers 102 (in FIG. 1, indicated by schema management servers A1 to An in which n is hereinafter a natural number and may have different values), a plurality of data operation clients 104 (in FIG. 1, indicated by data operation clients B1 to Bn), a plurality of data storage servers 106 (in FIG. 1, data storage servers C1 to Cn), and a plurality of operation request relay servers 108 (in FIG. 1, indicated by operation request relay servers D1 to Dn).

The information system 1 according to the present exemplary embodiment is realized by any combination of hardware and software of any computer which includes a central processing unit (CPU), a memory, a program loaded to the memory and realizing the constituent elements of this figure, a storage unit such as a hard disk storing the program, and a network connection interface. In addition, it can be understood by those skilled in the art that a method and a device realizing the same may have various modifications. Each drawing described below illustrates not a configuration in the hardware unit but a block in the function unit. Further, in each drawing, a configuration of a part which is not related to the essence of the present invention is not illustrated.

Each of the servers and clients forming the information system 1 according to the present exemplary embodiment may be implemented by a server computer, a personal computer, or a data processing apparatus corresponding thereto, which includes, for example, not illustrated, a CPU, a memory (or a processor), a hard disk, and a communication device, and is connected to an input device such as a keyboard or a mouse or an output device such as a display or a printer. In addition, the CPU can realize a function of each unit, which will be described later, by reading the program stored in the hard disk to the memory for execution.

Further, each of the servers and clients forming the information system 1 according to the present exemplary embodiment may be a virtualized computer such as a virtual machine, or a server group such as cloud computing which provides a service to users over a network.

The information system 1 of the present invention is applicable to an application such as a database which provides data distributed to and stored in different computers as a table structure in which at least a one-dimensional attribute range can be retrieved, and provides a data access function to a variety of application software.

In addition, the information system is also applicable to an application of a message transmission and reception form such as Publish/Subscribe for setting detection or notification of data occurrence by designating a condition regarding a range of multi-dimensional attributes in relation to a message or an event transmitted to the distributed computers.

Further, in a data stream process of designating a notification request as a D-dimensional range conditional expression before data having a certain D-dimensional attribute value is registered, a prestored range conditional expression may be treated as a 2D-dimensional attribute value, and data to be registered may be treated as a 2D-dimensional attribute range. For example, it is assumed that D=1, an attribute range of (25, 40) and an attribute range of (35, 40) are stored in advance, and data having an attribute value of A=30 is registered. The one-dimensional attribute range (25, 40) and the one-dimensional attribute range (35, 40) are stored as two-dimensional attribute values. The registered attribute value 30 is retrieved in a two-dimensional range ((−∞, 30), (30, ∞)). As a result, (25, 40) is acquired as a range including the attribute value, and (35, 40) is not acquired. A notification of this acquired result is performed. Hereinafter, the stream process is assumed to take this correspondence.

Here, for example, at least one-dimensional attribute data is data having a plurality of different attributes. Such data is assumed to be stored in a relational database which can be referred to and operated by a computer. In the relational database, there is a row (tuple) formed by a plurality of columns (attributes). In the present exemplary embodiment, especially, for fast retrieval of a designated column, a plurality of pairs of attributes are indexed with such as composite indexes. Examples of a plurality of attributes include longitude and latitude, temperature and humidity, or a price, a manufacturer, a model number, the release date, a specification, and the like of a product.

The information system 1 according to the present exemplary embodiment is applicable to, for example, a use scene in which a client accesses a shopping mall of a web site, and inputs a plurality of conditions, for example, a price range, a manufacturer, the release date, and the like in order to retrieve a product, thereby retrieving the corresponding product. When a request is received, the information system 1 may retrieve and extract data having an attribute suitable for the condition from the relational database and return the data to a client.

As described later in a subsequent exemplary embodiment, in the information system 1 of the present invention, there are a plurality of (multi-dimensional) retrieval conditions, and data retrieval may be performed using range-designated conditions. In addition, a frequency of retrieval requests or the like from clients to a web site is tens of thousands per second.

A destination may be determined as follows when a computer corresponding to at least a one-dimensional attribute value is determined, or a plurality of computers are determined in at least a one-dimensional attribute space in a case of range retrieval or the like, in a distributed environment including a plurality of computers which manage data having at least a one-dimensional attribute. That is, a correspondence between a partial space of at least the one-dimensional attribute space and the computer is generated in advance from destination server information and a data distribution, and the determination is performed with reference to the correspondence. Accordingly, even in a case where the number of attributes increase (for example, the number of attributes is about 5 to 9) or an attribute having a large bit length (for example, an INT type (32 bit length) or higher) is handled, a destination can be determined in a process with a low processing load.

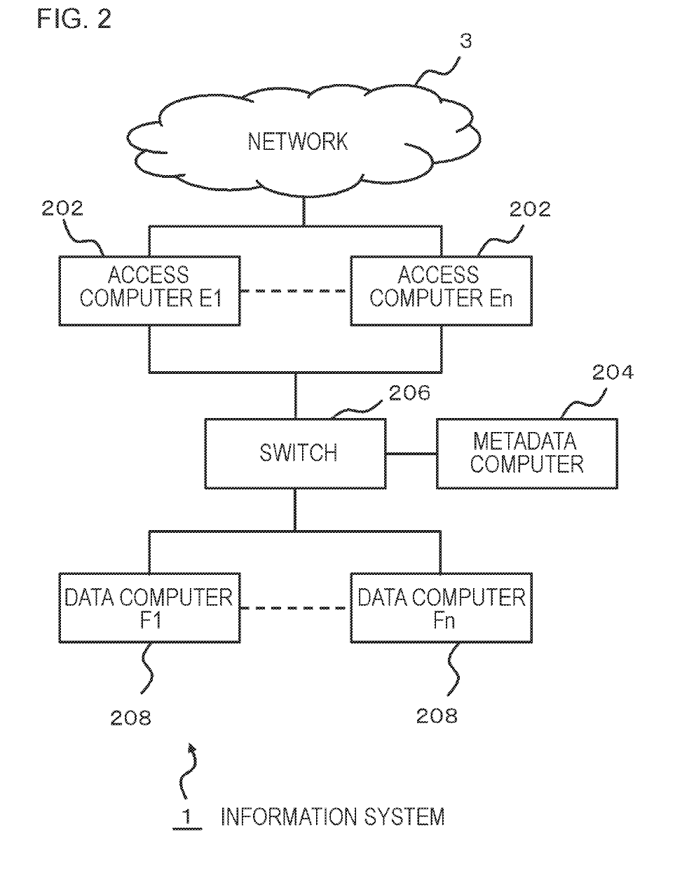

The information system 1 according to the present exemplary embodiment may have a configuration in which, for example, as illustrated in FIG. 2, a plurality of data computers 208 (in FIG. 2, indicated by data computers F1 to Fn) and mainly store data and access computers 202 (in FIG. 2, indicated by access computers E1 to En) which mainly issue a request for an operation of data, which are connected to each other through a switch 206, and connected to each other through the network 3.

In addition, the information system may have a configuration in which a metadata computer 204 which holds information (schema) regarding a structure of data stored in the data computers 208 is further provided.

In this configuration, the access computer 202 includes the data operation client 104 of FIG. 1, and the data computer 208 includes the data storage server 106 of FIG. 1.

The operation request relay server 108 of FIG. 1 may be provided in either or both of the access computer 202 and the data computer 208 of FIG. 2, but may be provided in neither thereof. The schema management server 102 of FIG. 1 may be provided in either of the access computer 202 and the data computer 208 of FIG. 2, or may be provided in the metadata computer 204 of FIG. 2.

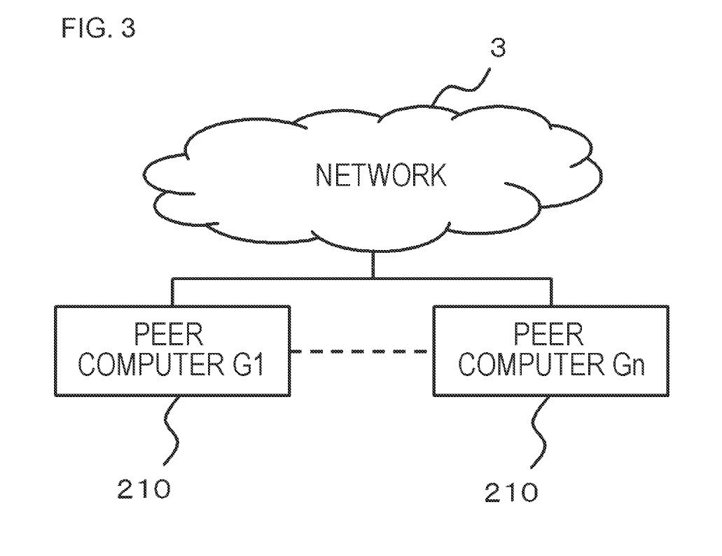

Alternatively, as another configuration example of the information system according to the present exemplary embodiment, as illustrated in FIG. 3, at least one peer computers 210 (in FIG. 3, indicated by peer computers G1 to Gn) which are connected to each other through the network 3 may be provided. The peer computers 210 may equally include the schema management server 102, the data operation client 104, the data storage server 106, and the operation request relay server 108.

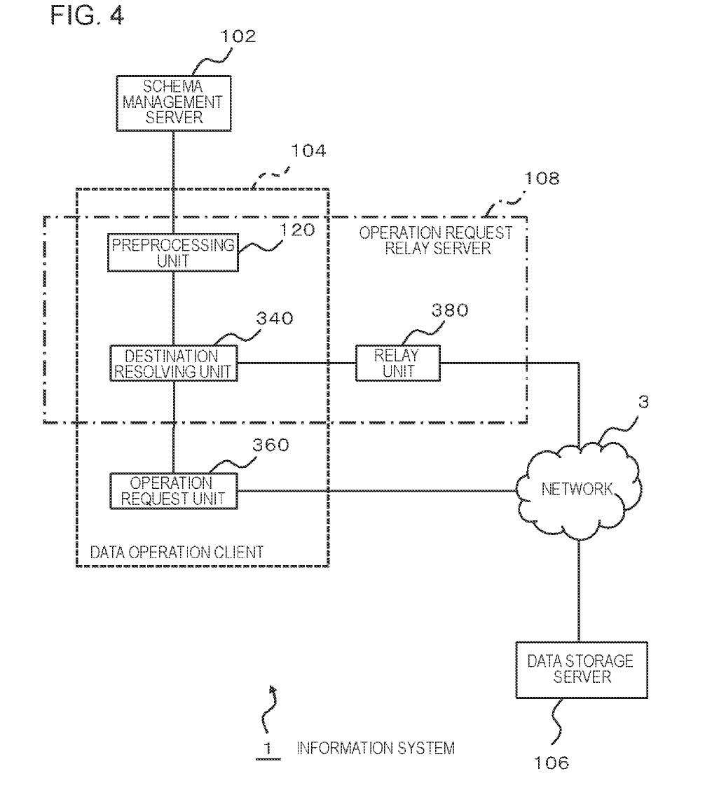

FIG. 4 is a functional block diagram illustrating a configuration of the information system 1 according to the present exemplary embodiment.

As illustrated in FIG. 4, the information system 1 according to the present exemplary embodiment includes the schema management server 102, a preprocessing unit 120, a destination resolving unit 340, an operation request unit 360, a relay unit 380, and the data storage server 106. In addition, in FIG. 4, the schema management server 102 and the preprocessing unit 120 are not connected to the network 3, but may be connected to the network 3.

In the present exemplary embodiment, the schema management server 102 generates distribution information which indicates a distribution of data of a data constellation.

The data of the data constellation stored in a plurality of nodes (the data storage servers 106) includes a set of data having attribute values in a predetermined condition range or a set of data having a predetermined similar distribution. A range of attribute values of data managed by each data storage server 106 is determined on the basis of the distribution of the data.

In the present exemplary embodiment, the data operation client 104 of FIG. 1 includes the preprocessing unit 120, the destination resolving unit 340, and the operation request unit 360 of FIG. 4. In addition, the operation request relay server 108 of FIG. 1 includes the preprocessing unit 120, the destination resolving unit 340, and the relay unit 380.

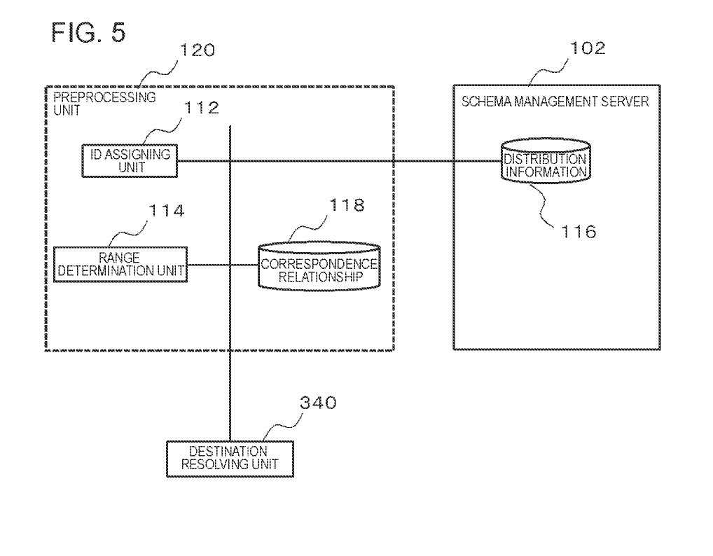

FIG. 5 is a functional block diagram illustrating a main part configuration of the information system 1 according to the present exemplary embodiment.

The information system 1 according to the present exemplary embodiment includes a plurality of nodes (the data storage servers 106) which manage a data constellation in a distributed manner.

The plurality of nodes (the data storage servers 106 (FIG. 1)) respectively has destination addresses each being identifiable on a network.

The information system 1 includes an identifier assigning unit (ID assigning unit 112), a range determination unit 114, and a destination determination unit (destination resolving unit 340).

The ID assigning unit 112 assigns logical identifiers to the plurality of nodes (data storage servers 106) on a logical identifier space.

The range determination unit 114 correlates the distribution of the data of the data constellation with the logical identifier space so as to determine a range of values of the data corresponding to the logical identifier of each node (data storage server 106). In addition, the range determination unit 114 uses distribution information 116 generated by the schema management server 102. The generation of the distribution information 116 will be described in detail in the subsequent exemplary embodiment.

The ID assigning unit 112 assigns a value in a finite identifier (ID) space to each node as a logical identifier ID (a destination, an address, or an identifier). The ID assigning unit 112 defines a range in the ID space of data managed by the node on the basis of the ID. An ID of a node which manages data may be obtained using a hash value of a key of data which is desired to be registered or acquired in the DHT. In addition, a hash value of a unique identifier (for example, an IP address and a port) which is assigned to the node at random or in advance may be used as a logical identifier ID of each node. Accordingly, load distribution can be achieved. The ID space includes a method of using a ring type, a method of using a HyperCube, and the like. Chord, Koorde, and the like use the ID space of the method of using the ring type.

In a case of using the ring type, a method of correlating a node with data is called consistent hashing. In the consistent hashing, the ID space has one-dimensional [0, 2^{m}) by using any natural number m, and each node i has a value xi in this ID space as an ID. Here, i is a natural number up to the number N of nodes, and is identified in an order of xi. In addition, the symbol “[” or the symbol “]” indicates a closed section, and the symbol “(” or the symbol “)” indicates an open section.

In this case, the node i manages data included in [xi, x(i+1)). However, a node of i=N manages data included in [0, x0) and [xN, 2^{m}).

In addition, a correspondence relation among a range of an attribute value space of data, a logical identifier, and a destination address of each node (the data storage server 106), generated by the range determination unit 114 is stored in a correspondence relation storage unit (in the figure, indicated by “correspondence relationship”) 118.

When searching for a destination of a node (the data storage server 106) which stores any data having any attribute value or any attribute range, the destination resolving unit 340 obtains a logical identifier corresponding to a range of data which matches at least a part of the attribute value or the attribute range on the basis of a correspondence relation among a range of values of data, a logical identifier, and a destination address, with respect to each node (the data storage server 106). In addition, the destination resolving unit 340 determines a destination address of a node (the data storage server 106) corresponding to the obtained logical identifier as a destination.

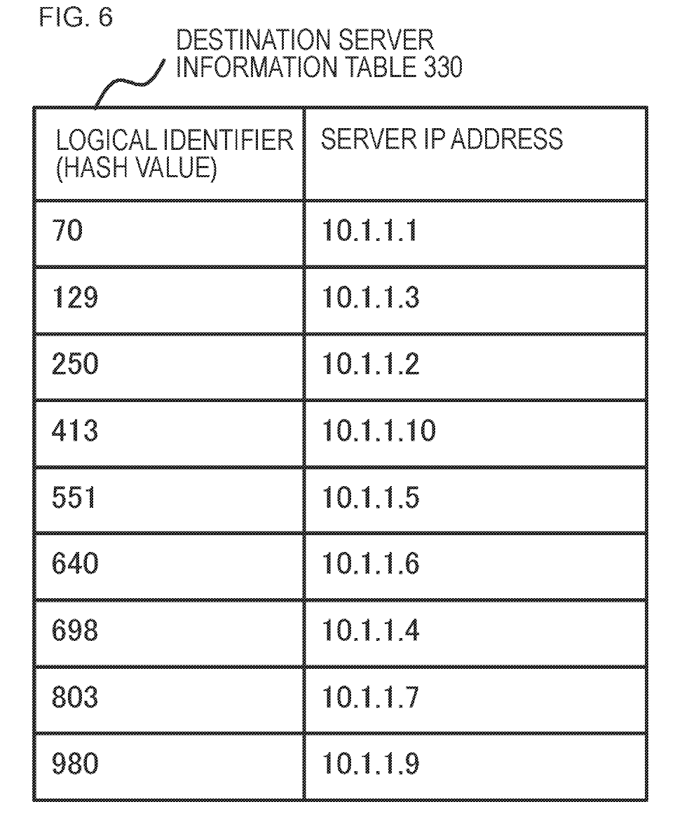

In the present exemplary embodiment, a set of logical identifiers (hash value) which are assigned to the respective nodes by the ID assigning unit 112 and destination addresses (server IP addresses) of the nodes which are destinations are correlated with each other so as to be stored in a destination server information table 330 of FIG. 6.

The above-described logical identifier which is assigned to each node by the ID assigning unit 112 is used to determine a data storage destination or a message transfer destination. As described above, logical identifiers are stochastically uniformly assigned to the respective nodes on the finite logical identifier space. A plurality of correspondences between the set of logical identifiers and the destination addresses are stored in the destination server information table 330 of FIG. 6.

For example, in a case of the consistent hashing or the distributed hash table, the logical identifier includes a hash value, an IP address of a destination computer, and the like.

Among various algorithms of the distributed hash table, for example, in a case of Chord, a successor list or a finger table corresponds to the destination server information table 330.

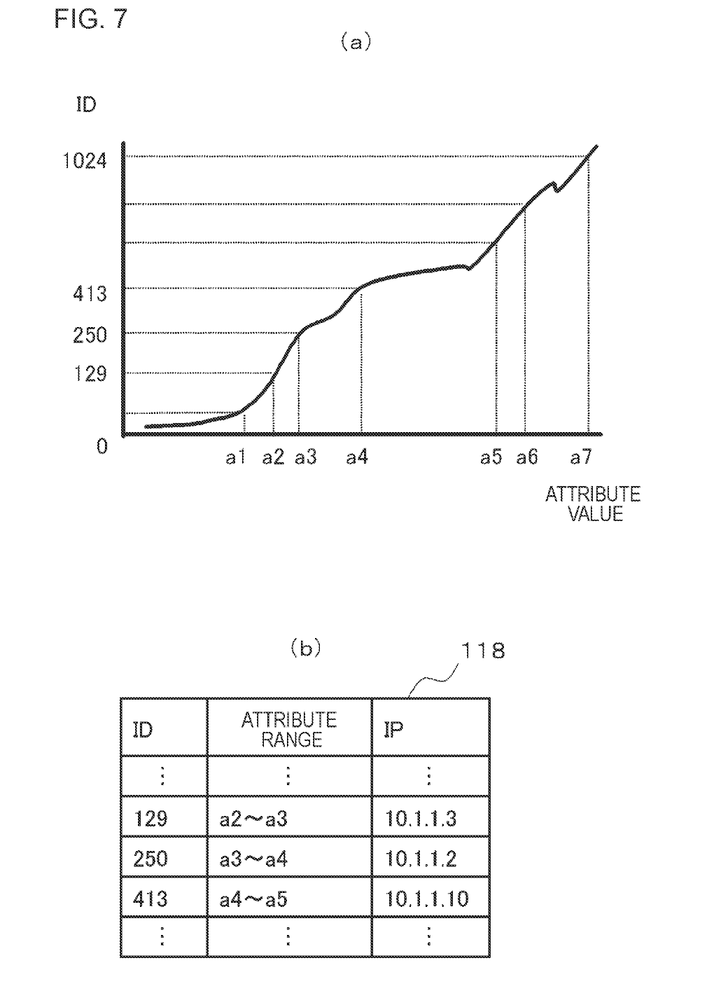

Here, a correspondence relation between a logical identifier (ID) assigned to a node and a range of attribute values of data managed by the node will be described with reference to FIG. 7.

In the present exemplary embodiment, in a case where the distribution information 116 based on a certain attribute value in a data constellation is indicated by a cumulative distribution as illustrated in FIG. 7(a), the range determination unit 114 may correlate an attribute value space with the transverse axis and correlate a logical identifier (ID) space with the longitudinal axis, so as to determine a range of an attribute value space corresponding to a logical identifier assigned to each node. For example, a node corresponding to the logical identifier 413 stores data in a range of the attribute values a4 to a5. Alternatively, only one endpoint (a5) of the attribute values may be managed. In this case, the other endpoint becomes an endpoint (a4) of the adjacent node (the node corresponding to the logical identifier 250). The correspondence relation between the ID and the range of the attribute values is determined in this way and is stored in the correspondence relation storage unit 118 as illustrated in FIG. 7(b).

In the present exemplary embodiment, the correspondence relation of FIG. 7(b) has a data structure of a destination table which is referred to when a plurality of nodes which manages a data constellation in a distributed manner are determined as destinations. In other words, an IP address of the node may be included as destination information of the node. The destination table includes correspondence relations among destinations of a plurality of nodes which manage a data constellation in a distributed manner, logical identifiers assigned to the respective nodes on a logical identifier space, and ranges of values of data managed by the respective nodes. In relation to the range of values of data of each node, a distribution of data in a data constellation is correlated with the logical identifier space, and a range of values of data corresponding to the logical identifier of each node is assigned to each node.

As described above, the logical identifiers are stochastically uniformly assigned to the respective nodes on the logical identifier space, and thus an attribute value range is determined in correlation with the logical identifier. As a result, a data constellation having a distribution based on the attribute values can be stochastically uniformly assigned to the respective nodes. However, each node has a data amount of a fraction of the number of nodes as a stochastic expected value, but it may not be secured that each node exactly has a data amount of a fraction of the number of nodes. A load on each node is stochastically uniformly assigned in accordance with the data distribution.

Next, a method for managing the information system 1 according to the present exemplary embodiment will be described below.

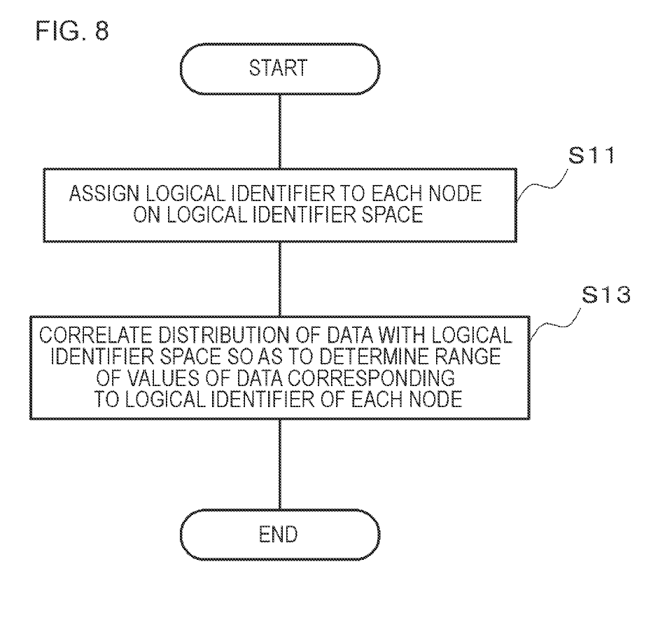

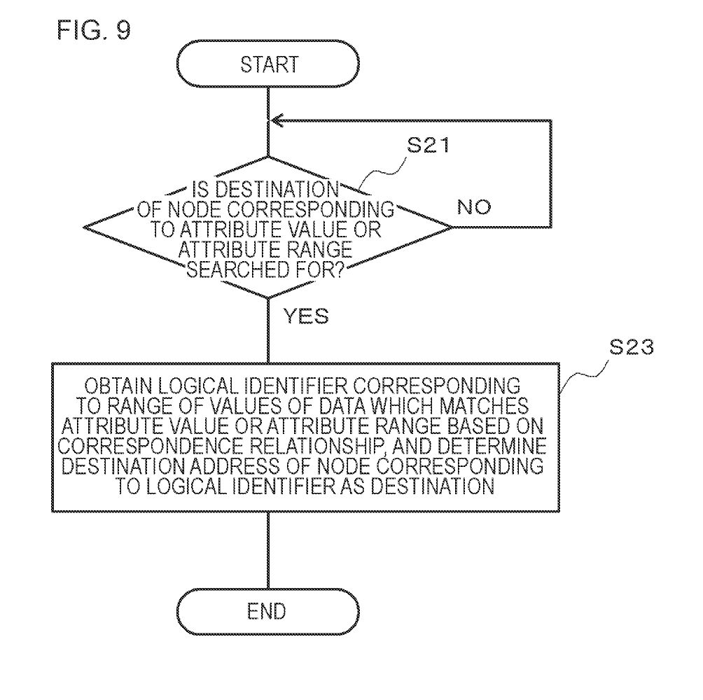

FIGS. 8 and 9 are flowcharts illustrating an operation performed by the information system 1 according to the present exemplary embodiment.

Hereinafter, a description thereof will be made with reference to FIGS. 5, 8 and 9.

In the method for managing the information system 1 according to the exemplary embodiment of the present invention, the ID assigning unit 112 (FIG. 5) of the preprocessing unit 120 (FIG. 5) assigns logical identifiers to a plurality of nodes on the logical identifier space (step S11 of FIG. 8). The range determination unit 114 (FIG. 5) correlates a distribution of data in a data constellation with the logical identifier space, and determines a range of values of data corresponding to the logical identifier of each node (step S13 of FIG. 8). When searching for a destination of a node which stores any data having any attribute value or any attribute range (YES in step S21 of FIG. 9), the destination resolving unit 340 (FIG. 5) obtains a logical identifier corresponding to a range of data which matches at least a part of the attribute value or the attribute range, on the basis of a correspondence relation among a range of values of the data, the logical identifier, and a destination address, with respect to each node, and determines the destination address of the node corresponding to the logical identifier as a destination (step S23 of FIG. 9).

In addition, a computer program according to the exemplary embodiment of the present invention causes a computer which realizes the data operation client 104 or the operation request relay server 108 of FIG. 4, to execute: a procedure for assigning logical identifiers to a plurality of nodes on the logical identifier space; a procedure for correlating a distribution of data in a data constellation with the logical identifier space so as to determine a range of values of the data corresponding to the logical identifier of each node; and a procedure for obtaining, when searching for the destination of a node which stores any data having any attribute value or any attribute range, a logical identifier corresponding to a range of the data which matches at least a part of the attribute value or the attribute range, on the basis of a correspondence relation among the range of values of the data, the logical identifier, and the destination address, with respect to each node, and determining the destination address of the node corresponding to the logical identifier as a destination.

The computer program according to the present exemplary embodiment may be recorded on a computer readable recording medium. The recording medium is not particularly limited, and may use media with various forms. In addition, the program may be loaded from the recording medium to a memory of a computer, and may be downloaded to the computer through a network and then be loaded to the memory.

An operation of the information system 1 of the present exemplary embodiment configured in this way will now be described.

In the preprocessing unit 120, the ID assigning unit 112 assigns logical identifiers to a plurality of nodes on the logical identifier space (step S11 of FIG. 8). In addition, the range determination unit 114 correlates a distribution of data in a data constellation with the logical identifier space, and determines a range of values of the data corresponding to the logical identifier of each node (step S13 of FIG. 8).

Further, in a case where a new node is added, the ID assigning unit 112 assigns a logical identifier to the new node on the logical identifier space (step S11 of FIG. 8), and the range determination unit 114 changes the ranges of values of the data corresponding to logical identifiers of nodes between the added new node and an adjacent node (not illustrated). Similarly, also in a case when a node is deleted, the range determination unit 114 changes the ranges of values of the data corresponding to logical identifiers of nodes between the deleted node and an adjacent node (another node having adjacent logical identifier) (not illustrated).

In addition, when the ID assigning unit 112 assigns the logical identifier to the new node, even if the existing node group has stochastic uniformity, there is a node of which an interval of a logical identifier between adjacent nodes is relatively wide, and a node of which an interval of a logical identifier between adjacent nodes is relatively narrow. The node having the wider interval has a large amount of data, and the node having the narrower interval has a small amount of data. The logical identifier assigned to the added new node has a high probability of entering a space where an interval between adjacent nodes is wide and a low probability of entering a space where an interval between adjacent nodes is narrow. For this reason, a range, which is determined from the logical identifier and the distribution information by the range determination unit 114, achieves an effect of receiving data from a node having a larger amount of data than other nodes, that is, there is a high probability that a load is reduced from a high load node and is thus uniformized.

In other words, in the information system 1 of the present invention, in a case when a node is added or deleted, data may be moved only in a part of nodes (a targeted node and adjacent nodes) without needing to move the data in all nodes, and thus stochastic uniformity can be maintained. In addition, if a single physical node has a plurality of logical identifiers, a movement of data is required to be performed with the other nodes corresponding to the number of logical identifiers.

Further, when searching for a destination of a node which stores any data having any attribute value or any attribute range on the basis of the correspondence relation determined in this way (YES in step S21 of FIG. 9), the destination resolving unit 340 obtains a logical identifier corresponding to a range of data which matches at least a part of the attribute value or the attribute range, on the basis of the correspondence relation among a range of values of the data, the logical identifier, and the destination address, with respect to each node, and determines the destination address of the node corresponding to the logical identifier as a destination (step S23 of FIG. 9).

As described above, according to the information system 1 of the present exemplary embodiment, it is possible to manage a storage destination of scalable data while maintaining a load between nodes to be uniform according to a distribution of data of a data constellation. This is because a range of values of data managed by each node is not determined so as to uniformize the number of records, but is determined according to data distribution by using a logical identifier which is obtained at random or from a hash value of an identifier of the node. For example, also in a case when a node is added or deleted, a range of managed data is not required to be changed in all nodes, and a range of values of the managed data only has to be changed among the added or deleted node and adjacent nodes thereof.

In addition, in the subsequent exemplary embodiment, a description will be made of a process of adding, deleting or retrieving data by receiving a data access request from a client terminal or the like which is provided with a service from an external application program.

### Second Exemplary Embodiment

An information system 1 of the present exemplary embodiment is different from that of the above-described exemplary embodiment in that a space-filling curve conversion process is performed on multi-dimensional attribute data, thereby obtaining data distribution information based on an attribute value, and thus a destination can be determined in the same manner for the multi-dimensional attribute data. In the present exemplary embodiment, the preprocessing unit 120 (FIGS. 4 and 5) of the information system 1 of the above-described exemplary embodiment is changed to a preprocessing unit 320.

Hereinafter, the information system 1 according to the present exemplary embodiment will be described.

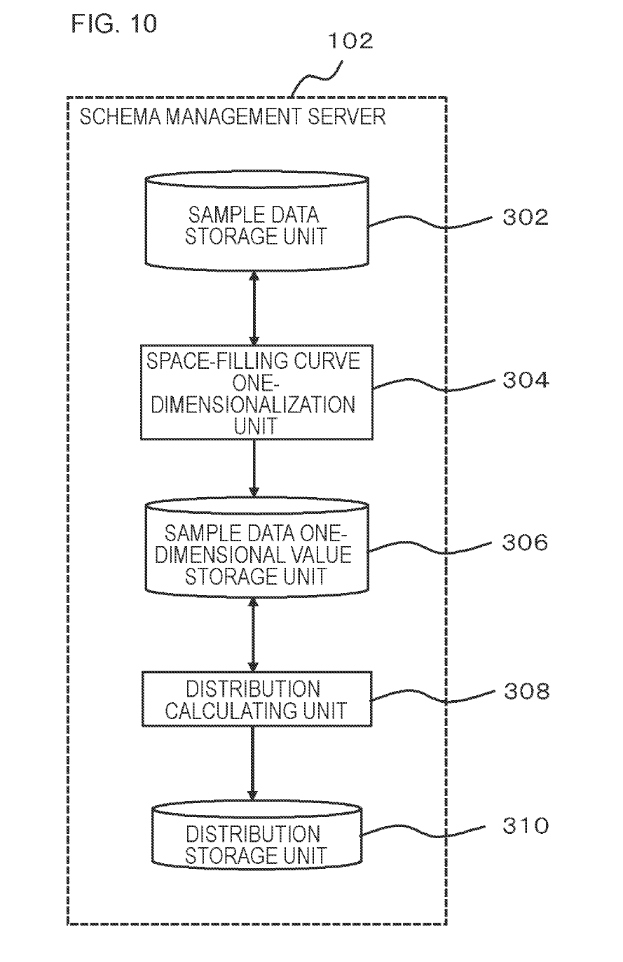

FIG. 10 is a functional block diagram illustrating a configuration of a schema management server 102 of the information system 1 according to the present exemplary embodiment.

In the information system 1 according to the present exemplary embodiment, a data constellation may include data having a multi-dimensional attribute. In addition, the information system 1 includes a space-filling curve one-dimensionalization unit 304 which performs a space-filling curve conversion process on a multi-dimensional attribute value included in data based on a predetermined attribute value from a data constellation so as to generate a one-dimensional value, and a distribution calculating unit 308 which calculates a cumulative distribution of the one-dimensionalized value generated by the space-filling curve one-dimensionalization unit 304.

In addition, the preprocessing unit 320 described later performs a process by using the cumulative distribution calculated by the distribution calculating unit 308 as distribution information.

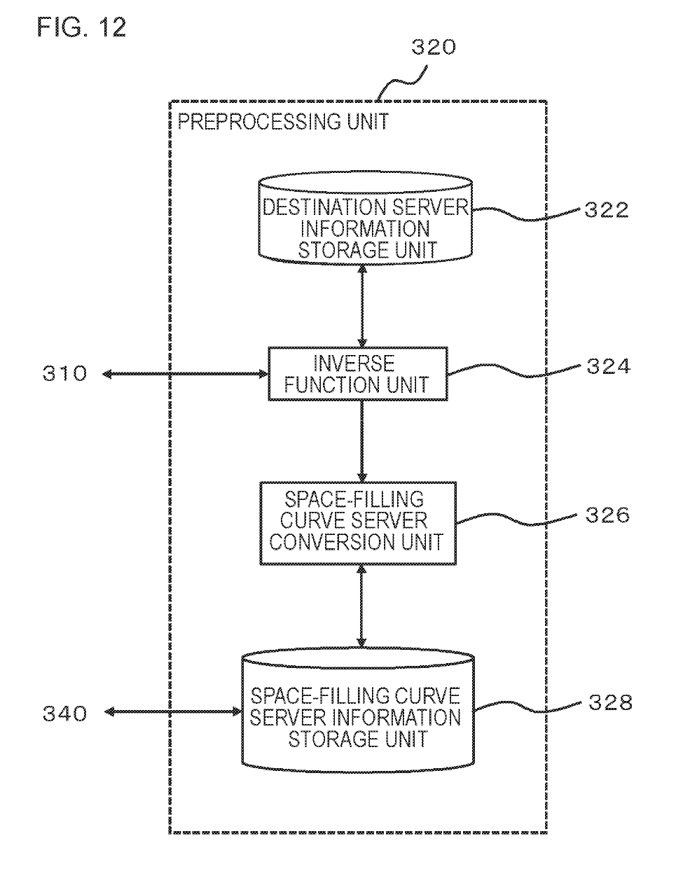

FIG. 12 is a functional block diagram illustrating a configuration of the preprocessing unit 320 of the information system 1 according to the present exemplary embodiment.

The information system 1 according to the present exemplary embodiment further includes an inverse function unit 324 which obtains a distribution function indicating a distribution of data of the data constellation and applies an inverse function of the distribution function by using a logical identifier of each node as an input so as to output a one-dimensional value, and a space-filling curve multi-dimensionalization unit (space-filling curve server conversion unit 326) which converts a one-dimensional value to derive a multi-dimensional value through a space-filling curve conversion process.

In addition, a set of one-dimensional values, which are generated by the inverse function unit 324 applying the inverse function, are converted to drive multi-dimensional values by the space-filling curve server conversion unit 326. The obtained multi-dimensional values, the logical identifiers, and the destination addresses are correlated with a set of the logical identifiers of the nodes, so as to be held as a correspondence relation.

Specifically, as illustrated in FIG. 10, the schema management server 102 includes a sample data storage unit 302, the space-filling curve one-dimensionalization unit 304, a sample data one-dimensional value storage unit 306, the distribution calculating unit 308, and a distribution storage unit 310, and generates distribution information in which data having a multi-dimensional attribute is one-dimensionalized.

A part of multi-dimensional attribute data which are stored in the distributed system, or sets of data having distribution information similar to each other are given to and stored in the sample data storage unit 302 in advance.

The sample data one-dimensional value storage unit 306 stores values obtained by converting sample multi-dimensional attribute data to derive a one-dimensional value.

The distribution storage unit 310 stores a part of multi-dimensional attribute data which is stored in the distributed system, or one-dimensional cumulative distribution information having the same distribution information as that of sets of data which have distribution information similar to each other.

The space-filling curve one-dimensionalization unit 304 converts a multi-dimensional attribute value to drive a one-dimensional value depending on a predetermined type of space-filling curve. The type of space-filling curve includes a Hilbert space-filling curve, a Z curve type space-filling curve, and the like. The conversion may be performed using a conversion rule table.

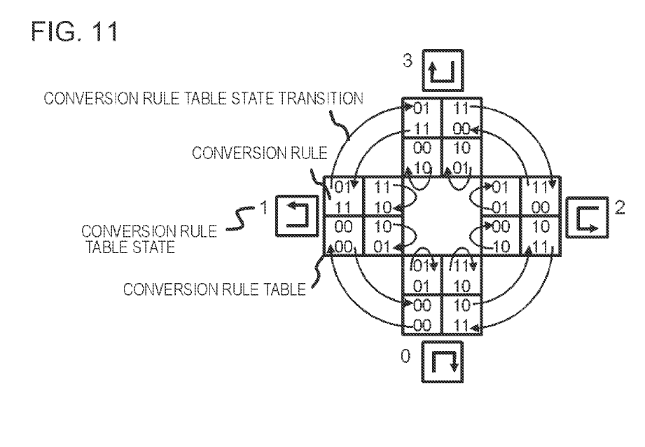

Here, a method of using a conversion rule illustrated in FIG. 11 will be described as a method of converting multi-dimensional data to drive a one-dimensional value, but other methods may be employed. FIG. 11 is a block diagram and a state transition diagram illustrating a conversion rule of a space-filling curve in the information system 1 according to the present exemplary embodiment. In addition, a Hilbert space-filling curve is used as the space-filling curve, and a conversion rule thereof is illustrated. However, a Z curve type space-filling curve may be used, and, in this case, a conversion rule different from that of FIG. 11 is used. The conversion rule of FIG. 11 shows a two-dimensional rule. An upper stage of the conversion rule indicates a multi-dimensional value in a specific bit, and a lower stage thereof indicates a corresponding one-dimensional value.

Since, in a two-dimensional case, four combinations of bits (00, 01, 10, 11) in the specific bits are possible, four conversion rules are referred to as a conversion rule table, and the conversion rule table is identified by conversion rule table states of (0, 1, 2, 3).

If a multi-dimensional value of a specific bit is given as an input in a certain conversion rule table state, a conversion rule which has the present multi-dimensional value in an upper stage thereof is selectively obtained from the conversion rule table of the present conversion rule table state, thereby obtaining a one-dimensional value at a corresponding lower stage. In addition, a transition to the next conversion rule table state corresponding to the multi-dimensional value is simultaneously made.

In the next state, a multi-dimensional value in a subsequent bit is given as an input, and a corresponding one-dimensional value is obtained. A value which is obtained by joining bits of the one-dimensional values obtained through the iterative state transitions, to each other in order from a leading bit, is output from the space-filling curve one-dimensionalization unit 304. The one-dimensional value output from the space-filling curve one-dimensionalization unit 304 (FIG. 10) is stored in the sample data one-dimensional value storage unit 306 (FIG. 10).

Referring to FIG. 10 again, the distribution calculating unit 308 calculates density distribution information or cumulative distribution information of data in a histogram or cumulative histogram form by using a set of one-dimensional values as an input. In the histogram indicating the density distribution information, the one-dimensional values may be separated at constant intervals, and the number of data items present within the respective intervals may be counted so that an amount thereof is used as a distribution amount.

Alternatively, the intervals may not be constant but may be different between respective separations, and a histogram may be expressed by a set of a pair of a distribution width and a distribution amount. In a case where a histogram is calculated, the histogram is converted to derive a cumulative histogram which takes a cumulative value in a direction in which one-dimensional values monotonously increase, thereby obtaining the cumulative histogram. The one-dimensional cumulative distribution information calculated by the distribution calculating unit 308 is stored in the distribution storage unit 310.

FIG. 12 is a functional block diagram illustrating a configuration of the preprocessing unit 320 of the information system 1 according to the present exemplary embodiment.

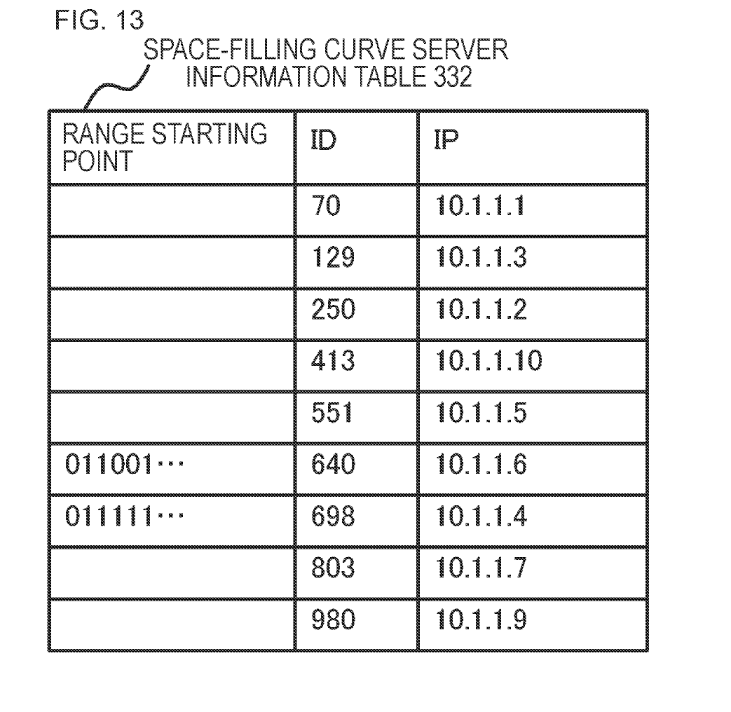

The information system 1 of the present exemplary embodiment further includes a destination server storage unit (destination server information storage unit 322) which stores a destination server table that correlates a set (range) of logical identifiers with corresponding destination addresses; the inverse function unit 324 which applies an inverse function of a distribution function using distribution information; and the space-filling curve multi-dimensionalization unit (space-filling curve server conversion unit 326) which converts a one-dimensional value to derive a multi-dimensional value through a space-filling curve conversion process. Accordingly, with reference to the destination server table, the inverse function unit 324 generates a set of one-dimensional values by applying an inverse function to a set of logical identifiers (hash values) that are assigned to respective computers (so that a distribution is statistically uniformized). The space-filling curve multi-dimensionalization unit (space-filling curve server conversion unit 326) converts the set of one-dimensional values to derive multi-dimensional values. The multi-dimensional values are correlated with the destination addresses so as to be stored in a correspondence information table (a space-filling curve server information table 332 (FIG. 13) of a space-filling curve server information storage unit 328) in advance.

Specifically, as illustrated in FIG. 12, the preprocessing unit 320 includes the destination server information storage unit 322, the inverse function unit 324, the space-filling curve server conversion unit 326, and the space-filling curve server information storage unit 328, and has a function of creating space-filling curve server information.

The destination server information storage unit 322 stores a plurality of correspondences between a set of logical identifiers and destination addresses of nodes, for determining a data storage destination or a message transfer destination, described above. For example, in a case of consistent hashing or a distributed hash table, a hash value, an IP address of a destination node, and the like are stored in the destination server information storage unit 322. The destination server information storage unit 322 may be provided in each node.

In addition, the information system 1 according to the present exemplary embodiment may further include an update unit (not illustrated) which changes, when a node on the network 3 is added or deleted, a set of logical identifiers of the nodes, and updates the correspondence relation (the destination server information table 330 of FIG. 6, and the space-filling curve server information table 332 of FIG. 13, which will be described later) in accordance with the change.

Among various algorithms of the distributed hash table, for example, in a case of Chord, a SuccessorList or a FingerTable corresponds to the correspondence relation.

Referring to FIG. 12 again, the space-filling curve server information storage unit 328 stores a plurality of destination addresses of other computers, for partial spaces of a multi-dimensional attribute space. In relation to a method of expressing the partial spaces of the multi-dimensional attribute space, for example, the partial spaces may be expressed by enumerating one-dimensional values of a starting point of the multi-dimensional attribute space, may be expressed by enumerating a sum of sets of attribute ranges corresponding to the number of dimensions, and may be expressed by enumerating a sum of sets of conditions specifying that any value is which position of bit in any dimension.

In the present exemplary embodiment, as illustrated in FIG. 13, the space-filling curve server information storage unit 328 correlates a value which expresses a starting point of a range (attribute space) of a logical identifier (ID) corresponding to a destination address (IP) in a one-dimensionalizing manner, with the destination address, and stores the value as the space-filling curve server information table 332. In addition, in FIG. 13, both of the logical identifier (ID) and the destination address (IP) are included in the space-filling curve server information table 332, but, for example, the logical identifier (ID) may not be included therein. Further, in a case where a correspondence table of the logical identifier (ID) and the destination address (IP) is provided separately, the space-filling curve server information table 332 may include either one of the logical identifier (ID) and the destination address (IP).

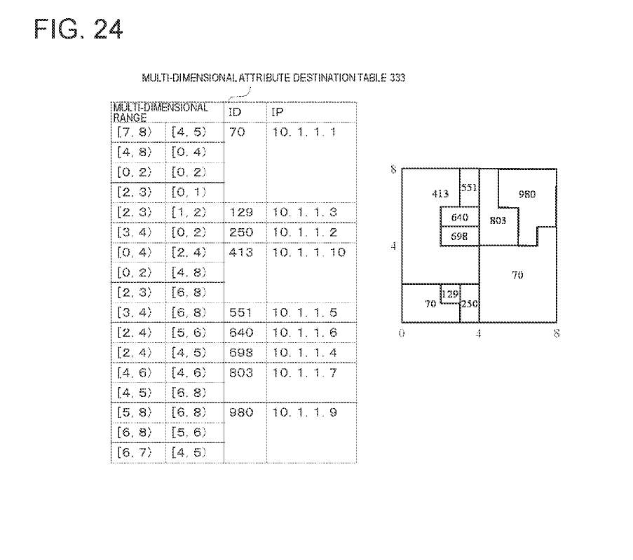

Here, the space-filling curve server conversion unit 326 (FIG. 12) may convert a one-dimensional value to derive a multi-dimensional value through a space-filling curve conversion process, so as to store not the one-dimensional value but the multi-dimensional value in the space-filling curve server information table 332. In a case where a one-dimensional value is stored in the space-filling curve server information table 332, if this value is to be referred to, the value is required to be referred to while performing a process using the space-filling curve on a given multi-dimensional attribute value or multi-dimensional attribute range. On the other hand, in a case where a multi-dimensional value is stored in the space-filling curve server information table 332, when this value is referred to, the process using the space-filling curve is not necessary. For example, as illustrated in a multi-dimensional attribute destination table 333 of FIG. 24, a multi-dimensional attribute range of each node may be converted to have a table form, and may be stored in the space-filling curve server information storage unit 328 as the space-filling curve server information table 332.

Referring to FIG. 12 again, the inverse function unit 324 uses the cumulative distribution information stored in the distribution storage unit 310, and outputs a one-dimensional value for an input value so that the one-dimensional value corresponds to a value obtained by applying an inverse function v=ICDF(r) of a cumulative distribution function r=CDF(v) which represents the cumulative distribution information as a function. In a case of using a cumulative histogram, a cumulative distribution ratio of the segment i is denoted by r[i], and a one-dimensional value is denoted by v[i].

For example, if a given input value is r from a table which is sorted in an ascending order in advance, in a case where there is a segment i where r[i]=r, v[i] is output. Otherwise, a segment i where r[i−1]<r<r[i] is found out, and then a corresponding one-dimensional value is calculated using the following Expression (1).

[Math. 1]

v=(r−r[i−1])(v[i]−v[i−1])/(r[i]−r[i−1])+v[i−1] Expression (1)

The space-filling curve server conversion unit 326 converts the one-dimensional value for each destination server, calculated by the inverse function unit 324, to derive a multi-dimensional value through a space-filling curve conversion process by using the one-dimensional value as an input. In addition, the space-filling curve server conversion unit 326 converts the one-dimensional value for each server to have a predetermined form of the space-filling curve server information in accordance with the above-described form of the space-filling curve server information table 332 stored in the space-filling curve server information storage unit 328, so as to create the space-filling curve server information table 332 and store the created space-filling curve server information table 332 in the space-filling curve server information storage unit 328. Further, the conversion of the form may not be performed, and information including a pair of an address of each server and a one-dimensional value obtained by the inverse function unit 324 may be held for use.

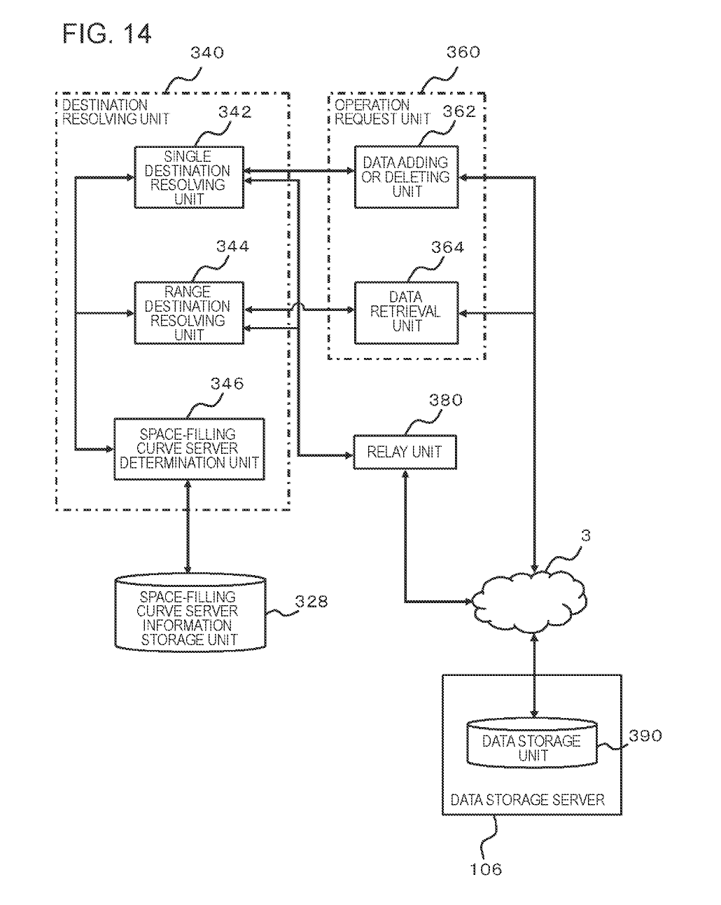

FIG. 14 is a functional block diagram illustrating a main part configuration of the information system 1 according to the present exemplary embodiment.

The information system 1 of the present exemplary embodiment further includes an operation request unit 360 which receives an operation request for processing of data with respect to a data constellation stored in a plurality of computers in a distributed manner, and also receives an attribute value corresponding to data regarding which operation request is received; and a transfer unit (the relay unit 380 or the operation request unit 360) which transfers the received operation request to a destination address which is determined by a determination unit (space-filling curve server determination unit 346). The determination unit (space-filling curve server determination unit 346) determines a destination address on the basis of the attribute value received by the operation request unit 360, and delivers the determined destination address to the relay unit 380 (or the operation request unit 360).

Specifically, as illustrated in FIG. 14, the destination resolving unit 340 includes a single destination resolving unit 342, a range destination resolving unit 344, and the space-filling curve server determination unit 346. In the present exemplary embodiment, the destination resolving unit 340 is configured to include both of the single destination resolving unit 342 and the range destination resolving unit 344, but is not particularly limited, and may include either one thereof.

In addition, the operation request unit 360 includes a data adding or deleting unit 362, and a data retrieval unit 364.

Further, the data storage server 106 includes a data storage unit 390.

The single destination resolving unit 342 acquires, by using a given multi-dimensional attribute value of data as an input, a destination address of a computer which is a destination to which the operation request regarding that data should be transmitted.

The range destination resolving unit 344 acquires, by using a given multi-dimensional attribute range as an input, a plurality of destination addresses of computers which are destinations to which the operation request regarding that data should be transmitted.

The space-filling curve server determination unit 346 acquires the space-filling curve server information stored in the space-filling curve server information storage unit 328. In addition, while referring to the space-filling curve server information, the space-filling curve server determination unit 346 returns one or a plurality of destinations of computers corresponding to the multi-dimensional attribute value or the multi-dimensional attribute range of which the single destination resolving unit 342 or the range destination resolving unit 344 has notified, to the single destination resolving unit 342 or the range destination resolving unit 344, respectively.

The data adding or deleting unit 362 (the operation request unit 360 of the data operation client 104 of FIG. 1) provides a data adding or deleting operation service of a user of an external application program or the like. In addition, if the application program is executed by the user and a data adding or deleting operation is requested, the data adding or deleting unit 362 acquires a value designated by the operation request in relation to a plurality of attributes which are determined to be preliminarily indexed with respect to the data which is a target of the operation request. Further, the data adding or deleting unit 362 acquires an address of a computer which is a destination to which the operation request regarding the multi-dimensional attribute value should be transmitted, from the destination resolving unit 340. Furthermore, the data adding or deleting unit 362 transfers the operation to the computer having the acquired destination address. When the data adding or deleting unit 362 of the computer (data storage server 106) in which the operation is to be performed receives the operation, a data adding or deleting process is performed on the corresponding data storage unit 390, and a result of the data adding or deleting process is returned to the program which has called the service.

Here, the application program is, for example, a web application, and includes application programs for various shopping sites and the like.

The data retrieval unit 364 (the operation request unit 360 of the data operation client 104 of FIG. 1) provides a data retrieval service to an external application program or the like. If the data retrieval process is performed, the data retrieval unit 364 acquires a range of a plurality of attributes which are determined to be preliminarily indexed with respect to the data on the basis of a retrieval expression designated by the retrieval request. In addition, the data retrieval unit 364 acquires a plurality of addresses of computers which are destinations to which an operation request regarding the multi-dimensional attribute range should be transmitted. Further, the data retrieval unit 364 transfers the operation to the respective corresponding computers. When the data adding or deleting unit 362 of the computer (data storage server 106) in which the operation is to be performed receives the operation, the data retrieval process is performed on the corresponding data storage unit 390, and a result of the data retrieval is returned to the program which has called the service.

In the present exemplary embodiment, the operation request unit 360 is configured to include both of the data adding or deleting unit 362 and the data retrieval unit 364, but is not particularly limited, and may include either one thereof. In addition, data processing units other than the data adding or deleting unit 362 or the data retrieval unit 364 may be provided. For example, the data processing unit may receive a request for such as a retrieval process on a plurality of condition-designated data sets, or a condition-designated update process and perform the corresponding process.

In addition, the information system 1 according to the present invention may include at least the space-filling curve server information storage unit 328 which stores the space-filling curve server information table 332, the space-filling curve server determination unit 346, and an operation request reception unit (not illustrated) which receives an operation request including an attribute value (including an attribute space) of data which is a processing target, from a user.

The relay unit 380 has a function of receiving an operation request which is transferred from the operation request unit 360 or the relay unit 380 of another computer, and of transferring the operation request to other computers. As described above, a transfer destination thereof is determined by inquiring the destination resolving unit 340 which is present in the same computer as the relay unit 380 about the transfer destination, on the basis of an attribute value or a retrieval condition regarding an attribute included in the received operation request.

The data storage unit 390 stores data which is stored in the distributed system, and performs reading or writing of data in response to a data writing or reading request from an external device.

In the above-described configuration, a method for managing the information system 1 of the present exemplary embodiment will now be described.

The method of managing the information system of the present exemplary embodiment includes processes, in addition to those of the method for managing according to the above-described exemplary embodiment, which are performed in the schema management server 102 (FIG. 10). In the method of managing the information system, the space-filling curve one-dimensionalization unit 304 (FIG. 10) performs a space-filling curve conversion process on a multi-dimensional attribute value included in data based on a predetermined attribute value from a data constellation so as to generate a one-dimensionalized value; the distribution calculating unit 308 (FIG. 10) calculates a cumulative distribution of the one-dimensionalized value; and the preprocessing unit 320 (FIG. 12) correlates the cumulative distribution calculated by the distribution calculating unit 308 (FIG. 10) as a distribution of the data with a logical identifier space.

In addition, the method of managing the information system 1 of the present exemplary embodiment includes processes which are performed in the preprocessing unit 320 (FIG. 12). In the method of managing, the inverse function unit 324 (FIG. 12) of obtains a distribution function indicating distribution information and applies an inverse function of the distribution function by using a logical identifier of each node as an input so as to output a one-dimensional value; and the space-filling curve server conversion unit 326 (FIG. 12) converts the one-dimensional value into a multi-dimensional value through a space-filling curve conversion process. The multi-dimensional values, the logical identifiers, and destination addresses are correlated with each other, so as to be held as a correspondence relation (the space-filling curve server information table 332 of FIG. 13).

As described in the former, in the present exemplary embodiment, the result output from the inverse function unit 324 is correlated with the logical identifiers and the destination addresses so as to be held as the correspondence relation (the space-filling curve server information table 332 of FIG. 13). As described in the latter, the space-filling curve server conversion unit 326 (FIG. 12) may convert a one-dimensional value into a multi-dimensional value so as to store not the one-dimensional value but the multi-dimensional value in the correspondence relation (the space-filling curve server information table 332 of FIG. 13).

An operation of the information system 1 of the present exemplary embodiment configured in this way will now be described.

First, a description will be made of an operation of the schema management server 102 which generates a multi-dimensional distribution in a one-dimensionalizing manner in the information system 1 of the present embodiment.

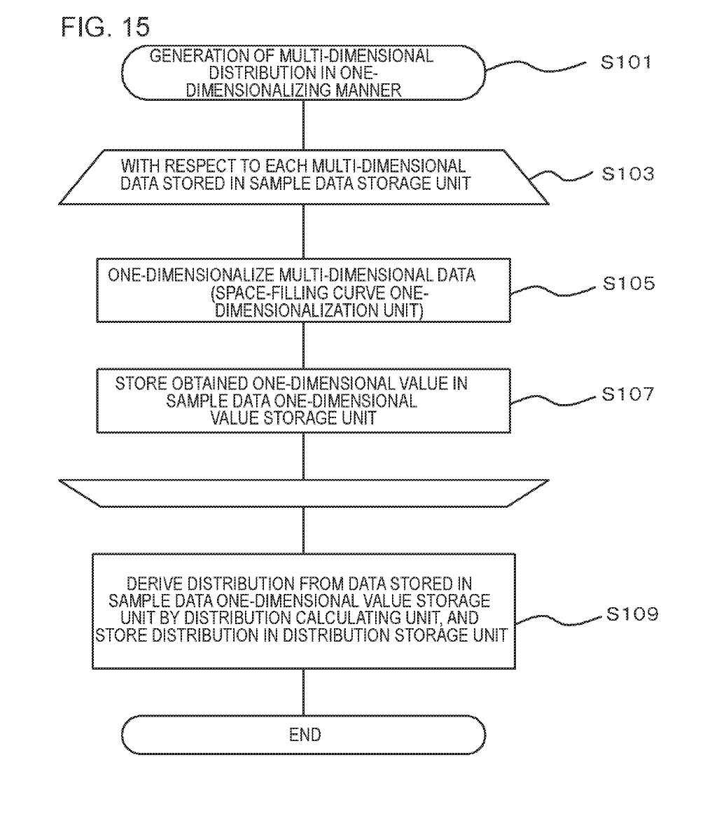

An operation of the schema management server 102 of the present embodiment will be described in detail. The operation is performed at timings such as the time when the information system 1 of the present embodiment is activated, a periodic manner, or the time when there is a manual request. FIG. 15 is a flowchart illustrating an example of a process (step S101) of generating a multi-dimensional distribution in a one-dimensionalizing manner in the schema management server 102 of the information system 1 of the present embodiment. Hereinafter, a description thereof will be made with reference to FIGS. 10 and 15.

First, the schema management server 102 repeatedly performs the following steps S103 to S107 on each piece of multi-dimensional data stored in the sample data storage unit 302 (step S103). In addition, the space-filling curve one-dimensionalization unit 304 one-dimensionalizes the multi-dimensional data by referring to the sample data storage unit 302 (step S105). The one-dimensional value obtained in step S105 is stored in the sample data one-dimensional value storage unit 306 (step S107). If the above-described process on the multi-dimensional data stored in the sample data storage unit 302 is completed, then, the distribution calculating unit 308 derives cumulative distribution information from the data stored in the sample data one-dimensional value storage unit 306, and stores the cumulative distribution information in the distribution storage unit 310 (step S109).

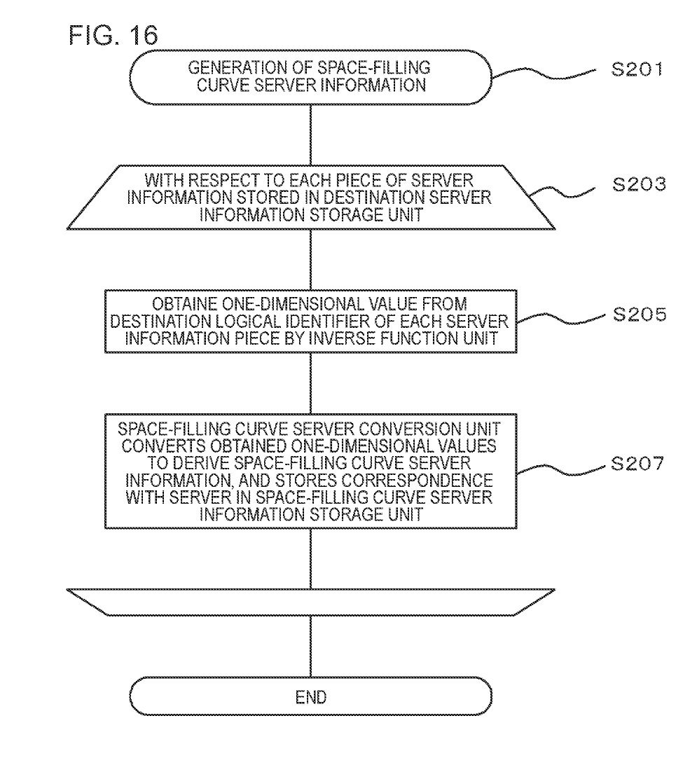

Next, an operation of the preprocessing unit 320 of the information system 1 of the present exemplary embodiment will be described. FIG. 16 is a flowchart illustrating an example of a process (step S201) of generating space-filling curve server information in the preprocessing unit 320 of the information system 1 of the present exemplary embodiment. Hereinafter, a description thereof will be made with reference to FIGS. 12 and 15.

First, the preprocessing unit 320 (FIG. 12) repeatedly performs the following steps S205 and S207 on each piece of the destination server information stored in the destination server information storage unit 322 (FIG. 12) (step S203). The inverse function unit 324 (FIG. 12) normalizes the logical identifier of destinations, and applies an inverse function to the normalized logical identifier so as to obtain a one-dimensional value (step S205). The inverse function unit 324 stores the one-dimensional value in the space-filling curve server information storage unit 328 (FIG. 12) as the space-filling curve server information table 332 of FIG. 13 (step S207). Alternatively, the space-filling curve server conversion unit 326 (FIG. 12) converts the one-dimensional value obtained in step S205 into a multi-dimensional attribute value, and stores space-filling curve server information obtained by performing this process on all pieces of server information, in the space-filling curve server information storage unit 328 (FIG. 12) (step S207).

Next, a description will be made of an operation of the destination resolving unit 340 which responds to an operation request in the information system 1 of the present exemplary embodiment.

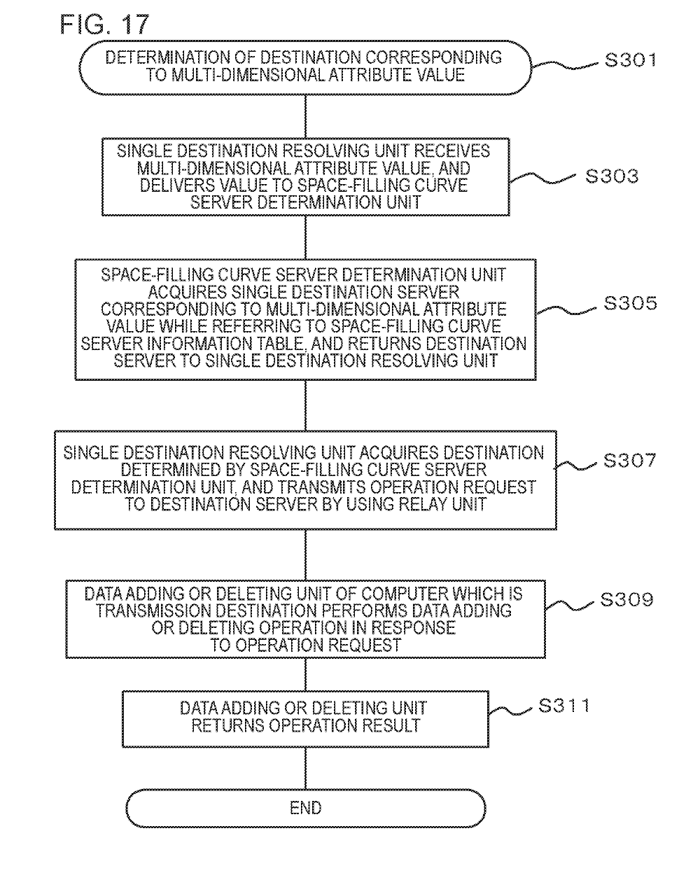

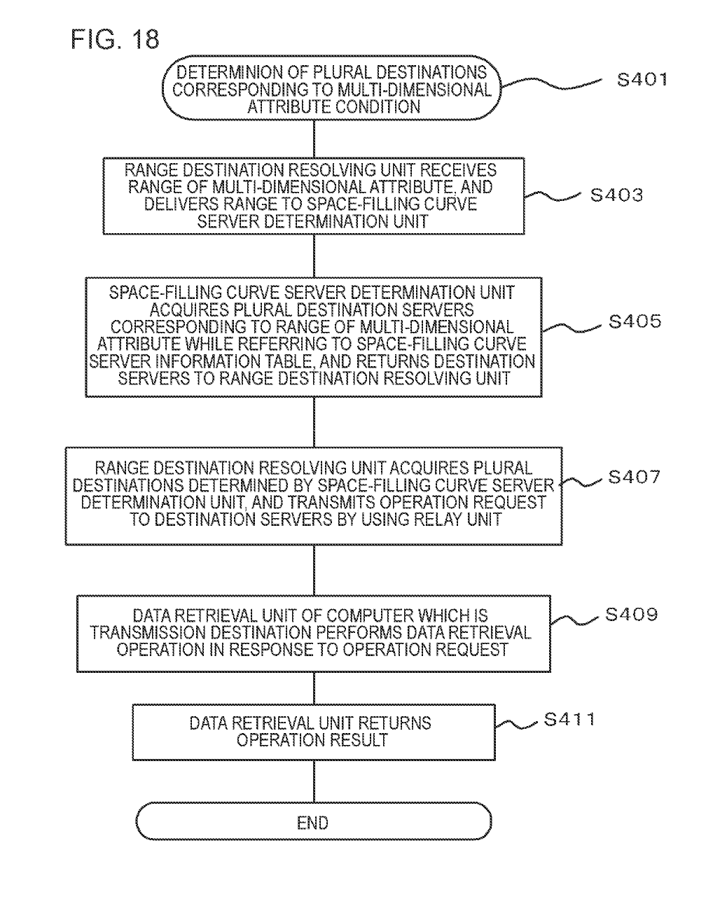

FIGS. 17 and 18 are flowcharts respectively illustrating examples of operations of a process (step S301) of determining a destination and a process (step S401) of determining a plurality of destinations, performed by the destination resolving unit 340 responding to an operation request in the information system 1 of the present exemplary embodiment.

A method for processing data of the present invention is a method for processing data of a client terminal (a terminal (not illustrated) which is provided with a service from an external application program) connected to a server which manages a plurality of nodes that manage a data constellation in a distributed manner, in which the client terminal notifies a management apparatus (the data operation client 104 or the operation request relay server 108 of FIG. 4) of an access request for data having an attribute value or an attribute range, and accesses a destination of a node (data storage server 106) managing data in a range which matches at least a part of the access-requested attribute value or attribute range, through the management apparatus on the basis of correspondence relations among destination addresses of the plurality of nodes (the data storage servers 106 of FIG. 4), logical identifiers assigned to the respective nodes (the data storage servers 106), and ranges of values of the data managed by the respective nodes (the data storage servers 106), so as to operate the data (step S309 of FIG. 17).

Specifically, first, an operation of the single destination resolving unit 342 which is used for an operation such as registration or deletion of data will be described with reference to FIGS. 13 and 14 and the flowchart of FIG. 17.

When a data adding or deleting operation service is executed by another computer in an external application program, the data adding or deleting unit 362 (FIG. 14) acquires values for a plurality of attributes which are determined to be preliminarily indexed with respect to the processing target data, through the network 3 (FIG. 14) and notifies the single destination resolving unit 342 (FIG. 14) of the values, thereby starting the present process.

First, the single destination resolving unit 342 (FIG. 14) receives a multi-dimensional attribute value from the data adding or deleting unit 362 (FIG. 14), and delivers the value to the space-filling curve server determination unit 346 (FIG. 14) (step S303). The space-filling curve server determination unit 346 (FIG. 14) acquires the space-filling curve server information table 332 (FIG. 13) stored in the space-filling curve server information storage unit 328 (FIG. 14). In addition, the space-filling curve server determination unit 346 acquires a destination (IP address) of a single computer (server) corresponding to the multi-dimensional attribute value while referring to the space-filling curve server information table 332, and returns the destination to the single destination resolving unit 342 (FIG. 14) (step S305).

Further, the single destination resolving unit 342 (FIG. 14) acquires the destination determined by the space-filling curve server determination unit 346 (FIG. 14), and transfers an operation request to another computer having the destination address through the network 3 (FIG. 14) by using the relay unit 380 (step S307). In addition, in the computer which is a transfer destination, the data adding or deleting unit 362 (FIG. 14) performs a data adding or deleting operation on the data storage unit 390 (FIG. 14) of the data storage server 106 (FIG. 14) in response to the operation request (step S309). Furthermore, the data adding or deleting unit 362 (FIG. 14) returns the operation result to the program (for example, the data operation client 104 of FIG. 1 which executes the program) which has called the service, through the network 3 (FIG. 14) (step S311).

Moreover, in the computer which is a transfer destination, in a case where the operation request is further required to be transferred, the single destination resolving unit 342 (FIG. 14) of the destination resolving unit 340 (FIG. 14) determines a destination on the basis of the multi-dimensional attribute value included in the operation request.

Next, an operation of the range destination resolving unit 344 used for a data retrieval operation will be described with reference to the flowchart of FIG. 18. Hereinafter, a description thereof will be made with reference to FIGS. 13, 14 and 18.

When a data retrieval service is executed by another computer in an external application program, the data retrieval unit 364 (FIG. 14) acquires a range of a plurality of attributes which are determined to be preliminarily indexed with respect to data on the basis of a retrieval expression designated by a retrieval request, through the network 3, and notifies the range destination resolving unit 344 (FIG. 14) of the range, thereby starting the present process.

First, the range destination resolving unit 344 (FIG. 14) receives the range of the multi-dimensional attributes from the data retrieval unit 364 (FIG. 14), and delivers the range to the space-filling curve server determination unit 346 (FIG. 14) (step S403). The space-filling curve server determination unit 346 (FIG. 14) acquires the space-filling curve server information table 332 (FIG. 13) stored in the space-filling curve server information storage unit 328 (FIG. 14). In addition, the space-filling curve server determination unit 346 acquires destinations (IP addresses) of a plurality of computers (servers) corresponding to the range of the multi-dimensional attribute values while referring to the space-filling curve server information table 332, and returns the destinations to the range destination resolving unit 344 (FIG. 14) (step S405).

Further, the range destination resolving unit 344 (FIG. 14) acquires the plurality of destinations determined by the space-filling curve server determination unit 346 (FIG. 14), and transfers an operation request to other computers respectively having the plurality of destination addresses through the network 3 (FIG. 14) by using the relay unit 380 (FIG. 14) (step S407). In addition, in each of the computers which are transfer destinations, the data retrieval unit 364 performs data retrieval on the data storage unit 390 (FIG. 14) of the data storage server 106 (FIG. 14) in response to the operation request (step S409). Furthermore, the data retrieval unit 364 (FIG. 14) returns the retrieval result to the program (for example, the data operation client 104 which executes the program) which has called the service, through the network 3 (FIG. 14) (step S411).

Moreover, in the computer which is a transfer destination, in a case where the operation request is further required to be transferred, the range destination resolving unit 344 (FIG. 14) of the destination resolving unit 340 (FIG. 14) determines destinations (IP addresses) of transfer destinations on the basis of the range of the multi-dimensional attributes included in the operation request.

As a specific example, in relation to a table such as, for example, CREATE TABLE user (char name, number age, number longitude, . . . ) in Structured Query Language (SQL), if there is a registration request such as INSERT INTO user (name, age, longitude, . . . ) VALUES (hoge, 20, 35.3 . . . , . . . ) in which two-dimensional attributes such as longitude and latitude are indexed, by using a command such as CREATE INDEX geo_idx ON user (longitude, latitude), the present method is applied to attribute values such as 35.3 . . . , and 140.1 . . . as the latitude and the longitude, and a primary key value such as name=hoge is stored in a storage destination. In this way, when retrieval is performed, a value regarding user.name can be acquired from a range of the latitude and the longitude, such as SELECT name FROM user WHERE user.age >20 and user.longitude . . . .

In other words, in the present exemplary embodiment, the data retrieval unit 364 (FIG. 14) receives the registration request such as INSERT INTO user (name, age, longitude, . . . ) VALUES (hoge, 20, 35.3 . . . , . . . ), and the range destination resolving unit 344 (FIG. 14) acquires a value regarding user.name from ranges of the latitude and the longitude, such as SELECT name FROM user WHERE user.age >20 and user.longitude . . . .

As described above, according to the information system 1 of the present exemplary embodiment, distribution information can be generated for data having multi-dimensional attribute values, and the data having multi-dimensional attribute values can be statistically uniformly assigned to respective nodes on the basis of the distribution information.

In addition, according to the information system 1 of the present exemplary embodiment, before operations such as registration, deletion, and retrieval of data are performed, destination information of a computer which manages an attribute value or data for an attribute partial space can be prepared in the following procedures.

In other words, a one-dimensional value for each destination server may be calculated on the basis of the information of the destination server information table 330 (FIG. 6) stored in the destination server information storage unit 322 (FIG. 12) and the data distribution information by using the inverse function unit 324 (FIG. 12); a multi-dimensional value may be output by the space-filling curve server conversion unit 326 (FIG. 12) by using the given one-dimensional value as an input; and destination information for the attribute partial space or the attribute value may be stored in the space-filling curve server information storage unit 328 (FIG. 12) on the basis of a pair of the multi-dimensional value and the destination server.

In addition, when operations such as registration, deletion, and retrieval of data are performed, the destination information for an attribute value or an attribute partial space can be acquired from the space-filling curve server information storage unit 328 (FIG. 12), and thus corresponding destination information can be acquired on the basis of a given attribute value or attribute condition.

That is, with this configuration, it is possible to specify a computer having a subset of data based on a preliminarily indexed attribute value (including an attribute space) at a high speed. In addition, it is possible to retrieve data having a certain attribute value (including an attribute space) at a high speed. This is because the space-filling curve conversion process is not required to be performed throughout, and a destination server can be determined in the middle. In other words, this is because, in the middle of obtaining a multi-dimensional value through the space-filling curve conversion process on an attribute value, checking begins from a leading bit of a value which expresses a multi-dimensional value corresponding to the attribute value in a one-dimensional manner while referring to the correspondence information table, and, when an assignment range corresponding to the attribute value is found, a destination address corresponding to the multi-dimensional value can be determined.

As above, according to the information system 1 of the present exemplary embodiment, even in a case where the number of attributes (the number of dimensions) attached with composite indexes is large when operations such as registration, deletion, and retrieval of data are performed, it is possible to achieve an effect of performing at a high speed a process of determining a destination to which request information of the operations is transferred on the basis of an attribute value of data or a condition regarding the attribute value.

This is because, when registration, deletion, or retrieval of data is performed, it is not necessary to perform a process of converting a multi-dimensional attribute value or attribute condition into a one-dimensional value or range.

In addition, there is a problem in that, in order to perform an operation such as registration, deletion, or retrieval of data, when a destination to which request information of the operation is transferred is determined on the basis of an attribute value of data or a condition regarding an attribute, if a bit length of data attached with composite indexes is large, a calculation time required for the determination increases, and thus performance such as a response time of the operation deteriorates.

This is because, in a process of converting an attribute value attached with composite indexes into a one-dimensional value in a space-filling curve processing unit, the time required for the conversion increases as a bit length becomes larger. Particularly, when a single one-dimensional value is not output during registration or deletion of data, but a range of one-dimensional values is output during retrieval, the time required for conversion increases.

For example, the systems disclosed in the above-described Patent Documents have a problem in that, in order to perform an operation such as registration, deletion, or retrieval of data, when a destination to which request information of the operation is transferred is determined on the basis of an attribute value of data or a condition regarding an attribute value, if the number of attributes (the number of dimensions) attached with composite indexes is large, a calculation time required for the determination increases, and thus performance such as a response time of the operation deteriorates.

This is because, in a process of converting an attribute value attached with composite indexes into a one-dimensional value in a space-filling curve processing unit, the time required for the conversion increases as the number of dimensions increases. Particularly, when a single one-dimensional value is not output during registration or deletion of data, but a range of one-dimensional values is output during retrieval, the time required for conversion increases.

According to the information system 1 of the present exemplary embodiment, even in a case where a bit length of a data type attached with composite indexes is large when operations such as registration, deletion, and retrieval of data are performed, it is possible to achieve an effect of performing at a high speed a process of determining a destination to which request information of the operations is transferred on the basis of an attribute value of data or a condition regarding the attribute value.

This is because, when registration, deletion, or retrieval of data is performed, it is not necessary to perform a process of converting a multi-dimensional attribute value or attribute condition into a one-dimensional value or range.

### EXAMPLES

Next, a best mode operation for carrying out the present invention will be described using specific examples. Hereinafter, a description thereof will be made with reference to FIGS. 1, 2, 10, 12 to 14, 16, and 19 to 23.

In this example, as illustrated in FIG. 2, a description will be made of an example of operating data stored in a plurality of data computers 208 from the access computer 202. It is assumed that the access computer 202 of FIG. 2 includes the data operation client 104 of FIG. 1, the metadata computer 204 of FIG. 2 includes the schema management server 102 of FIG. 1, and the data computer 208 of FIG. 2 includes the data storage server 106 of FIG. 1.

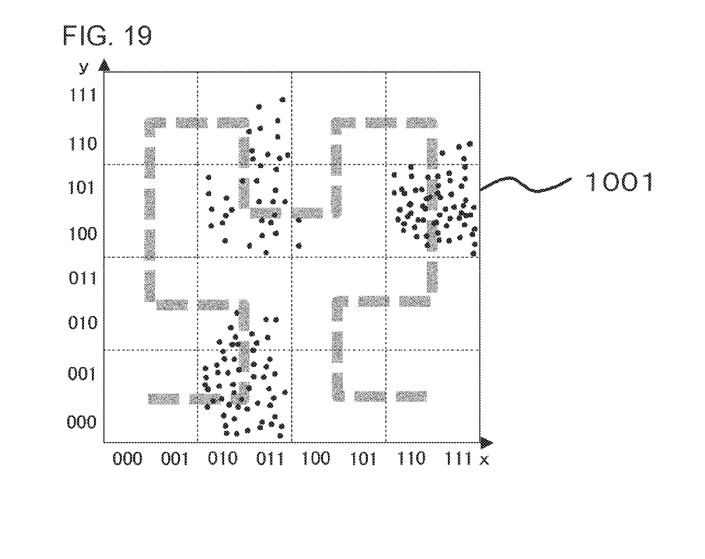

In this example, it is assumed that a data distribution 1001 of FIG. 19 is stored in the sample data storage unit 302 of the schema management server 102 of FIG. 10 in the metadata computer 204 of FIG. 2.

In a process of generating space-filling curve server information of FIG. 16 in the schema management server 102 (FIG. 10), first, the space-filling curve one-dimensionalization unit 304 of FIG. 10 one-dimensionalizes a multi-dimensional attribute value of each data shown in the data distribution 1001 of FIG. 19, and stores the one-dimensionalized value in the sample data one-dimensional value storage unit 306 of FIG. 10. Next, the distribution calculating unit 308 of FIG. 10 calculates cumulative distribution information of the stored one-dimensional values in a form of a cumulative histogram or the like, and stores the information in the distribution storage unit 310 of FIG. 10.

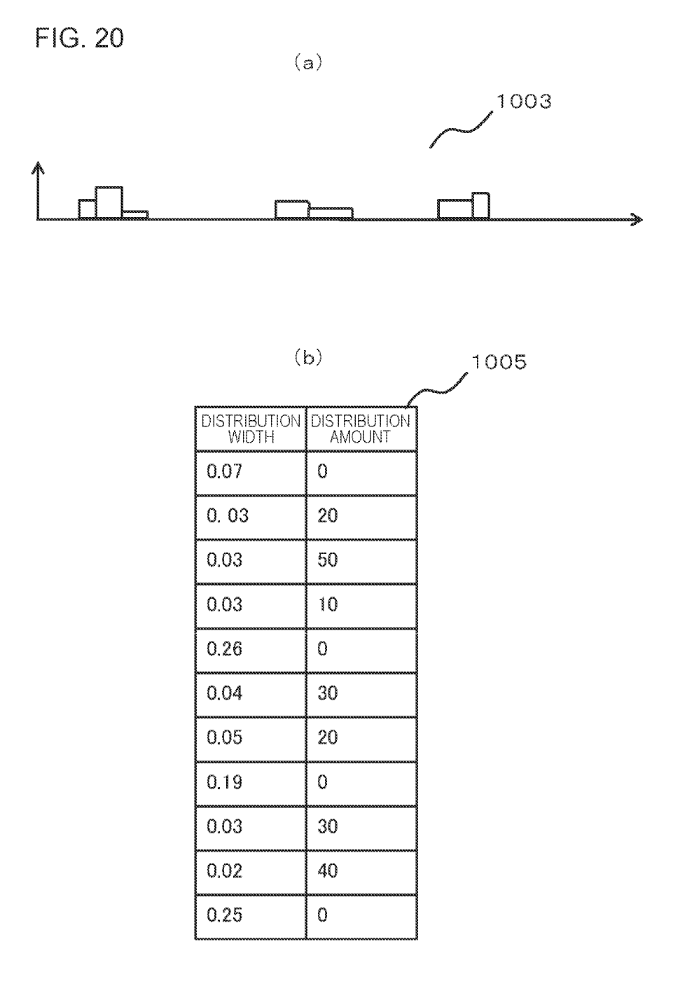

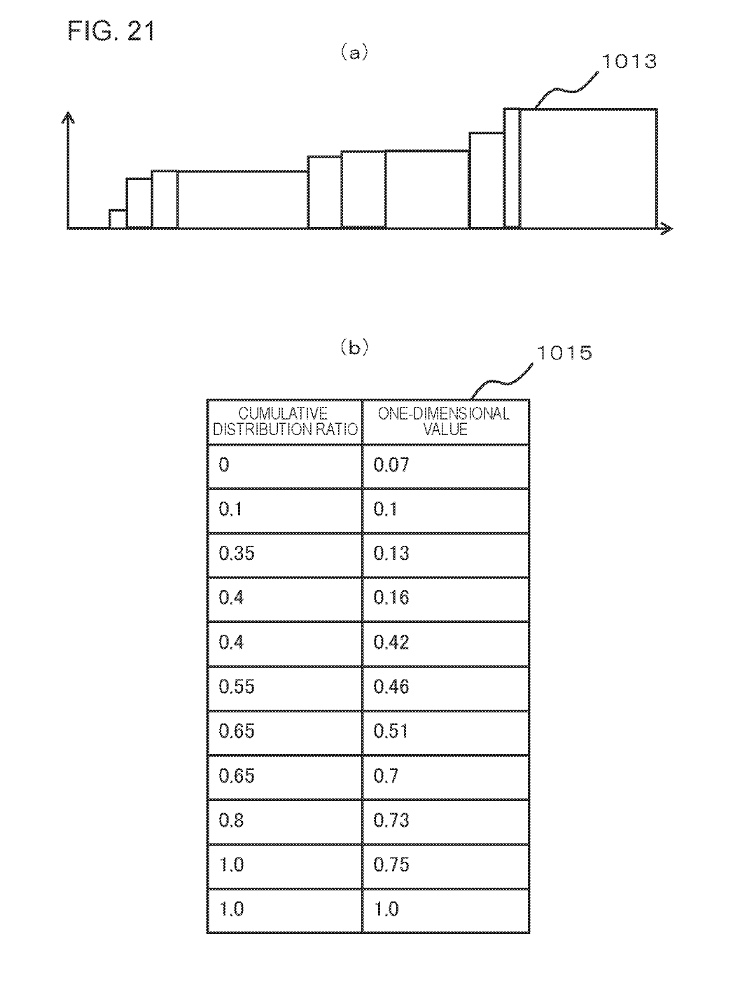

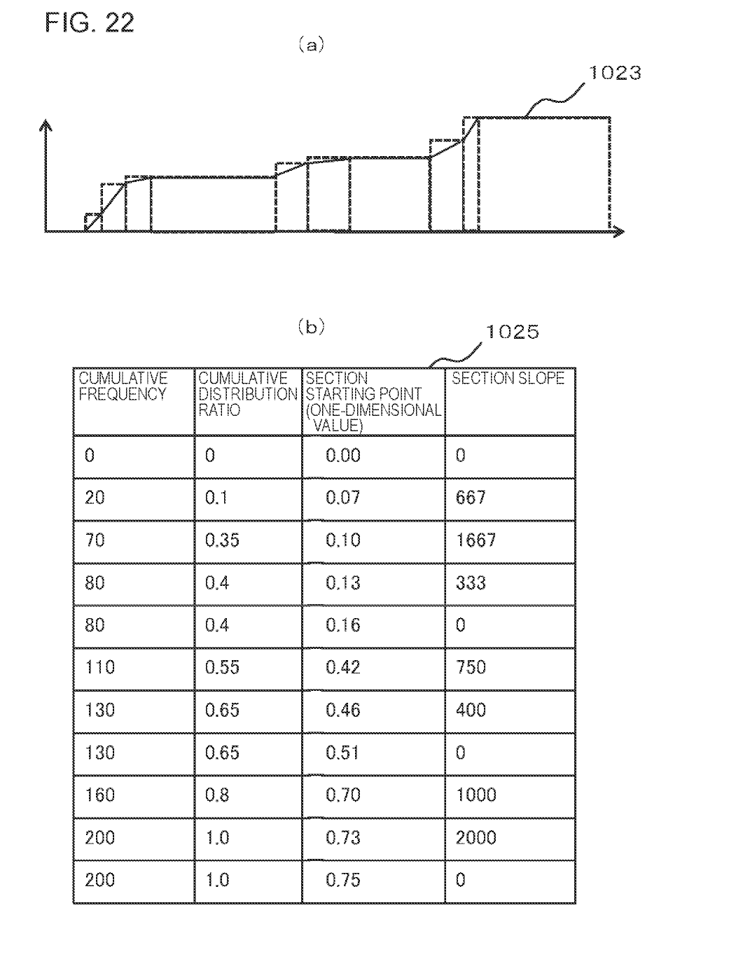

First, it is assumed that, in the distribution calculating unit 308 of FIG. 10, a histogram is obtained as density distribution information 1003 illustrated in FIG. 20(a). Here, the histogram is assumed to be expressed by a table 1005 including a distribution width and a distribution amount illustrated in FIG. 20(b). A cumulative distribution ratio, which is obtained by converting the density distribution into a cumulative distribution and by dividing a distribution amount of each segment by a sum total of distribution amounts, is illustrated in a table 1015 of FIG. 21(b), and this corresponds to the cumulative distribution information (cumulative histogram) 1013 of FIG. 21(a). In addition, with respect to the distribution width as illustrated in cumulative distribution information 1023 of FIG. 22(a), a slope of a distribution amount (in the figure, indicated by “section slope”) may be stored in a table 1025 as illustrated in FIG. 22(b). The slope of a distribution amount is stored in the table 1025, and thus it is not necessary to calculate (v[i]−v[i−1])/(r[i]−r[i−1]) in Expression (1) described in the above-described exemplary embodiment every time.

In this example, it is assumed that nine data computers 208 of FIG. 2 are present, and information regarding addresses (IP addresses or the like) for accessing the data computers 208 of FIG. 2 is stored in the access computer 202 of FIG. 2. The information is illustrated in the server IP address column of the space-filling curve server information table 332 (FIG. 13) stored in the destination server information storage unit 322 of FIG. 12.

A value, obtained by the ID assigning unit 112 inputting each of the server IP addresses to a hash function such as Secure Hash Algorithm (SHA) 1 or Message Digest Algorithm 5 (MD5), is calculated as a logical identifier of each of the servers, and the calculated logical identifiers are stored in the same destination server information storage unit 322 of FIG. 12. The logical identifier is distributed in a range of [0,2^{b}) in which a logical identifier space size determined by the hash function is 2^{b}.

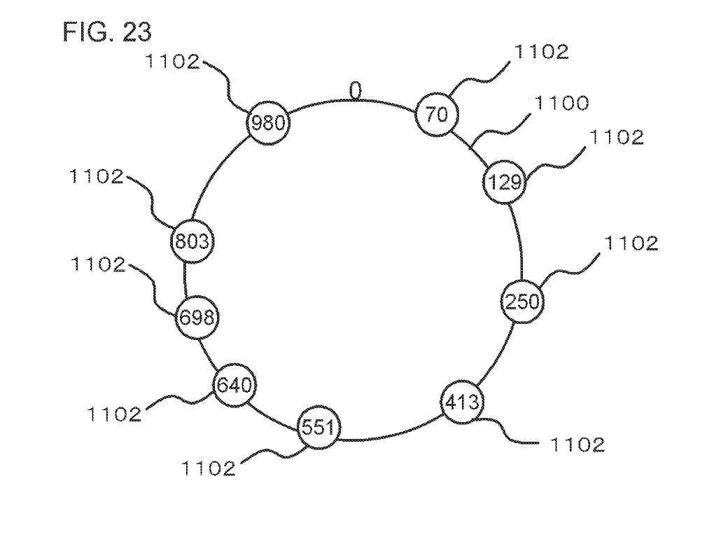

As described above, the symbol “[” or the symbol “]” indicates a closed interval, and the symbol “(” or the symbol “)” indicates an open interval. Hereinafter, a logical identifier space 1100 is shown in a ring shape as illustrated in FIG. 23, and logical identifiers 1102 disposed on the circle indicate respective computers. In addition, hereinafter, a value obtained by dividing the logical identifier by the logical identifier space size is used as a normalized logical identifier. This is distributed in a range of [0, 1). Further, it is assumed that the respective computers are stochastically uniformly assigned to the logical identifier space 1100 independently from a distribution of attribute values.

In the process (step S201 of FIG. 16) of generating space-filling curve server information of FIG. 16, performed by the access computer 202 (FIG. 2), the inverse function unit 324 (FIG. 12) converts the normalized logical identifier into a one-dimensional value for each server stored in the destination server information table 330 of FIG. 6. At this time, the inverse function unit 324 (FIG. 12) refers to the cumulative distribution information of the distribution storage unit 310 (FIG. 10) of the schema management server 102 (FIG. 10). In a procedure for calculating the inverse function described here by using, for example, the table 1015 (FIG. 21(b)) of the cumulative histogram, if 0.35 is given as an input normalized logical identifier, 0.13 is returned.

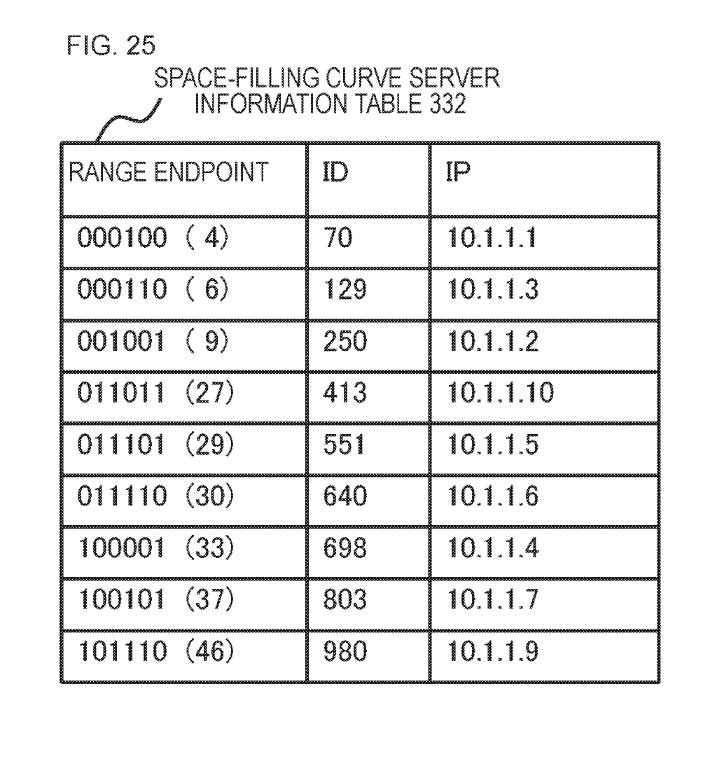

If 0.36 is given, 0.136 is derived from (0.36-0.35)*(0.16-0.13)/(0.4-0.35)+0.13 and then returned. The one-dimensional value which is distributed in [0, 1], obtained in this way, may be represented by [000 . . . , 111 . . . ) in a binary expression. The space-filling curve server conversion unit 326 (FIG. 12) stores the one-dimensional value in a binary expression and the information regarding the IP address of each server in the space-filling curve server information storage unit 328 (FIG. 12) as the space-filling curve server information table 332 as illustrated in FIG. 25. In addition, in this example, the space-filling curve server conversion unit 326 (FIG. 12) converts only a form. Further, in the example of FIG. 25, not a starting point of the range but a range endpoint is held for the one-dimensional value.

In the access computer 202 (FIG. 2), the data adding or deleting unit 362 (FIG. 14) receives a data registration request, and the single destination resolving unit 342 (FIG. 14) determines a destination corresponding to an indexed multi-dimensional attribute value on the basis of data.

Here, a two-dimensional attribute value is exemplified, and this value is assumed to be (3, 4), that is, (011, 100) in a binary expression.

The space-filling curve server determination unit 346 (FIG. 14) extracts the leading bit of each dimension so as to obtain a first multi-dimensional bit (01). An initial conversion rule table state is assumed to be 0.

A first one-dimensional bit (01) is output as an output on the basis of the conversion rule of the state 0. Here, with reference to the space-filling curve server information, a pointer is moved to the range endpoint 011011 (27) of which a bit pattern of the range endpoint begins from the one-dimensional bit 01.

In the conversion rule, since a conversion rule table state is 0 when an input multi-dimensional bit string is 01, a transition to another table is not made, and the same table is used.

A second multi-dimensional bit (10) is obtained as the next bit. A second one-dimensional bit (11) is output as an output on the basis of the conversion rule, and is added to the previous bit string, thereby obtaining a one-dimensional bit (0111). The pointer is moved to the range endpoint 011101 (29) beginning from the obtained value 0111. A conversion rule table of a transition destination corresponding to the second multi-dimensional bit (10) is 2, and thus the conversion rule table thereof is acquired.

A third multi-dimensional bit (11) is extracted as the next bit, and a third one-dimensional bit (00) is output so as to be added to the previous bit string in the conversion rule table of the state 2, thereby obtaining a one-dimensional bit (011100), that is, 28 in a decimal expression.

A node which manages the values as a range has a logical identifier of 551, and thus a node whose IP is 10.1.1.5 is selected from the space-filling curve server information table 332 illustrated in FIG. 25. In this way, a destination can be determined.

As above, the exemplary embodiments of the present invention have been described with reference to the drawings, but they are only an example of the present invention, and various configurations other than described above may be employed.

While the invention has been particularly shown and described with reference to exemplary embodiments thereof, the invention is not limited to these exemplary embodiments. It will be understood by those of ordinary skill in the art that various changes in form and details may be made therein without departing from the spirit and scope of the present invention as defined by the claims.

This application is based upon and claims the benefit of priority from Japanese Patent Application No. 2011-211157, filed on Sep. 27, 2011; the disclosure of which is incorporated herein in its entirety by reference.

1. An information system comprising:
a plurality of nodes that manage a data constellation in a distributed manner, the plurality of nodes respectively having destination addresses being identifiable on a network;
an identifier assigning unit that assigns logical identifiers to the plurality of nodes on a logical identifier space;
a range determination unit that correlates a distribution of data in the data constellation with the logical identifier space so as to determine a range of values of the data corresponding to the logical identifier of each of the nodes; and
a destination determination unit that obtains, when searching for a destination of a node which stores any data having any attribute value or any attribute range, a logical identifier corresponding to a range of the data which matches at least a part of the attribute value or the attribute range, on the basis of a correspondence relation among the range of values of the data, the logical identifier, and the destination address, with respect to each of the nodes, and determines the destination address of the node corresponding to the logical identifier as a destination.

2. The information system according to claim 1,
wherein the data constellation includes data having a multi-dimensional attribute, and
wherein the information system further comprises:
a space-filling curve one-dimensionalization unit that performs a space-filling curve conversion process on a multi-dimensional attribute value included in data based on a predetermined attribute value from the data constellation so as to generate a one-dimensionalized value; and
a distribution calculating unit that calculates a cumulative distribution of the one-dimensionalized value generated by the space-filling curve one-dimensionalization unit, and
wherein the range determination unit correlates the cumulative distribution calculated by the distribution calculating unit as a distribution of the data with the logical identifier space

3. The information system according to claim 2, further comprising:
an inverse function unit that obtains a distribution function indicating a distribution of the data and applies an inverse function of the distribution function by using the logical identifier of each of the nodes as an input so as to output a one-dimensional value; and
a space-filling curve multi-dimensionalization unit that converts the one-dimensional value into a multi-dimensional value through a space-filling curve conversion process,
wherein the multi-dimensional values, the logical identifiers, and the destination addresses are correlated with a set of the logical identifiers of the nodes, so as to be held as the correspondence relation.

4. The information system according to claim 1,
wherein the data of the data constellation which is managed in a distributed manner by the plurality of nodes includes a set of data having attribute values in a predetermined condition range or a set of data having a predetermined similar distribution.

5. The information system according to claim 1, further comprising:
an operation request reception unit that receives an operation request for processing of data with respect to the data constellation stored in the plurality of nodes in a distributed manner, and also receives an attribute value corresponding to the data regarding which operation request is received; and
a transfer unit that transfers the received operation request to the destination address which is determined by the destination determination unit,
wherein the destination determination unit determines the destination address on the basis of the attribute value received by the operation request reception unit, and delivers the destination address to the transfer unit.

6. The information system according to claim 5,
wherein the operation request received by the operation request reception unit is related to registration, deletion or retrieval of the data.

7. The information system according to claim 1, further comprising:
a storage unit that stores the correspondence relation for each of the nodes.

8. The information system according to claim 1, further comprising:
an update unit that changes the set of the logical identifiers of the nodes, and updates the correspondence relation in accordance with the change, when the node on the network is added or deleted.

9. A method for managing an information system which manages a plurality of nodes that manage a data constellation in a distributed manner, the plurality of nodes respectively having destination addresses being identifiable on a network, and the information system including a management apparatus and a storage device,
the method for managing comprising:
assigning, by the management apparatus, logical identifiers to the plurality of nodes on a logical identifier space;
correlating, by the management apparatus, a distribution of data in the data constellation with the logical identifier space so as to determine a range of values of the data corresponding to the logical identifier of each of the nodes; and
obtaining, when searching for the destination of a node which stores any data having any attribute value or any attribute range, by the management apparatus, a logical identifier corresponding to a range of the data which matches at least a part of the attribute value or the attribute range, on the basis of a correspondence relation among the range of values of the data, the logical identifier, and the destination address, with respect to each of the nodes so as to determine the destination address of the node corresponding to the logical identifier as a destination.

10. A non-transitory computer-readable storage medium with a program for a computer stored thereon, the program realizing a management apparatus which manages a plurality of nodes that manage a data constellation in a distributed manner, the plurality of nodes respectively having destination addresses being identifiable on a network, and the management apparatus including a storage device, the program causing the computer realizing the management apparatus to execute:
a procedure for assigning logical identifiers to the plurality of nodes on a logical identifier space;
a procedure for correlating a distribution of data in the data constellation with the logical identifier space so as to determine a range of values of the data corresponding to the logical identifier of each of the nodes; and
a procedure for obtaining, when searching for the destination of a node which stores any data having any attribute value or any attribute range, a logical identifier corresponding to a range of the data which matches at least a part of the attribute value or the attribute range, on the basis of a correspondence relation among the range of values of the data, the logical identifier, and the destination address, with respect to each of the nodes so as to determine the destination address of the node corresponding to the logical identifier as a destination.

11. A method for processing data of a terminal apparatus which is connected to the management apparatus employing the method for managing an information system according to claim 9 and accesses the data through the management apparatus, the method for processing data comprising:
notifying, by the terminal apparatus, the management apparatus of an access request for data having an attribute value or an attribute range; and
accessing, by the terminal apparatus, a destination of the node managing the access-requested data in a range which matches at least a part of the attribute value or attribute range, through the management apparatus, on the basis of correspondence relations among destination addresses of the plurality of nodes, logical identifiers assigned to the respective nodes, and ranges of values of the data managed by the respective nodes, so as to operate the data.

12. A non-transitory computer-readable storage medium with a program for a computer stored thereon, the program realizing a client terminal connected to a server which manages a plurality of nodes that manage a data constellation in a distributed manner, the plurality of nodes respectively having destination addresses being identifiable on a network, the program causing the computer realizing the client terminal to execute:
a procedure for receiving an access request for data having an attribute value or an attribute range;
a procedure for notifying the server of the received access request;
a procedure for obtaining the logical identifier corresponding to a range of the data which matches at least a part of the access-requested attribute value or attribute range on the basis of correspondence relations among destination addresses of the plurality of nodes, logical identifiers assigned to the respective nodes, and ranges of values of the data managed by the respective nodes so as to receive a destination address of the node corresponding to the logical identifier determined as the destination from the server; and
a procedure for accessing the node having the destination address received from the server so as to operate the data having the attribute value or the attribute range.

13. A data structure of a destination table which is referred to when determining destinations of a plurality of nodes which manage a data constellation in a distributed manner,
wherein the plurality of nodes respectively have destination addresses being identifiable on a network,
wherein the destination table includes correspondence relations among destination addresses of the plurality of nodes which manage the data constellation in a distributed manner, logical identifiers assigned to the respective nodes on a logical identifier space, and ranges of values of data managed by the respective nodes, and
wherein, in relation to the range of values of the data of each of the nodes, a distribution of the data in the data constellation is correlated with the logical identifier space, and the range of values of the data corresponding to the logical identifier of each node is assigned to each node.
